(19) United States
(12) Patent Application Publication
(10) Pub. No.: US 2025/0165876 A1
(43) Pub. Date: May 22, 2025

(54) Reservation management device and method

(71) Applicant: PLUGO, Inc., Tokyo (JP)

(72) Inventors: Yuya Okada, Tokyo (JP); Naoki Okawa, Tokyo (JP)

(21) Appl. No.: 18/839,961

(22) PCT Filed: Jan. 12, 2023
(86) PCT No.: PCT/JP2023/000661

§ 371 Date: Nov. 7, 2024

(30) Foreign Application Priority Data
Feb. 21, 2022 (JP) 2022-025173
Sep. 28, 2022 (JP) 2022-155044
Nov. 29, 2022 (JP) 2022-189935

(51) Int. Cl. G06Q 10/02

(52) U.S. Cl. CPC G06Q 10/02; B60L 53/60

(57) ABSTRACT

Reservation managing device includes: a state acquiring unit for acquiring information on presence or absence of a vehicle in a charging space; a reservation managing unit for determining whether a use state of the charging space is a reservation available state based on the information acquired by the state acquiring unit, and for accepting a reservation for the charging space in a case where the charging space is in a reservation available state; and a restricting unit for putting a restricting device provided in the charging space into a state for restricting use of the charging space, in a case where the reservation has been accepted by the reservation managing unit.

### RELATED APPLICATIONS

This application claims priority to Japanese Patent Application No. 2022-025173 filed on Feb. 21, 2022, entitled “CHARGING AND ENTERING MANAGING SYSTEM”, Japanese Patent Application No. 2022-155044, filed on Sep. 28, 2022, entitled “CHARGING AND ENTERING MANAGING SYSTEM”, and Japanese Patent Application No. 2022-189935, filed on Nov. 29, 2022, entitled “RESERVATION MANAGING DEVICE AND METHOD”, the contents of which are incorporated herein by reference in the entirety.

### TECHNICAL FIELD

The present invention relates to a reservation managing device and a method for managing a reservation.

### BACKGROUND ART

As a background art of the present technical field, Japanese Patent No. 7046407 (Patent Literature 1) is cited. This publication describes a reservation system: “The reservation system includes a reservation processing unit for reserving an electric vehicle and a shared facility having at least one parking area in which a charger capable of charging a battery of an electric vehicle is installed. The maximum number of reservations for the shared facility is set to the number of at least one parking area. The reservation system further includes a reservation fee determining unit for determining a reservation fee of an electric vehicle. The electric vehicle is one of a plurality of electric vehicles to be managed, and the reservation fee determining unit is capable of deciding a reservation fee of an electric vehicle based on the number of unreserved electric vehicles (see Abstract).”

### CITATION LIST

### Patent Literature

[Patent Literature 1] JP 7046407 B1

### SUMMARY

### Technical Problem

According to the reservation system 10 described in the Patent Document 1, it is possible to reserve not only an electric vehicle but also a shared facility having a parking area in which a charger capable of charging a battery of an electric vehicle is installed (see PARA. 0015). In addition, the shared facility database 122 includes a facility managing number, facility location information, a maximum number of reservations, and a possible number of reservation (or a non-reserved number) for each date (see PARA. 0036). However, the Patent Document 1 does not discuss a system for accepting a reservation while providing a parking area in which a charger is installed to a vehicle without having a reservation.

Therefore, the present invention provides a system capable of accepting a reservation for a charging space while providing a charging space even for a vehicle without having a reservation.

### Solution to Problem

In order to solve the above-mentioned problems, for example, the configurations described in the claims can be adopted.

Although the present application includes a plurality of means for solving the above-mentioned problems, for example, according to an embodiment, a reservation managing device is provided. The reservation managing device includes: a state acquiring unit for acquiring information on presence or absence of a vehicle (here, the term “vehicle” is interchangeable with other similar variations such as “automobile”, “car”, “motorcar”, “motor vehicle”, etc.) in a charging space; a reservation managing unit for determining whether a use state of the charging space is a reservation available state based on the information acquired by the state acquiring unit, and for accepting a reservation for the charging space in a case where the charging space is in a reservation available state; and a restricting unit for putting a restricting device provided in the charging space into a state for restricting use of the charging space, in a case where the reservation has been accepted by the reservation managing unit.

### Effects of the Invention

According to the present invention, it is possible to provide a system capable of accepting a reservation for a charging space while providing a charging space even for a vehicle without having a reservation. Accordingly, it becomes possible to guarantee use of a charging space for a vehicle having a reservation while making it possible to provide a vacant charging space to be used by a vehicle without having a reservation. As a result, it becomes possible to increase the operating rate of the charging space.

Problems, configurations, and effects other than those described above will be apparent from the following description of embodiments.

### BRIEF DESCRIPTION OF DRAWINGS

FIG. 1 is an example of a whole configuration of a reservation managing system 100;

FIG. 2 is an example of a hardware configuration of a charging space managing device 101;

FIG. 3 is an example of a hardware configuration of a managing server 102;

FIG. 4 is an example of a hardware configuration of a user terminal 103;

FIG. 5 is an example of user information 500;

FIG. 6 is an example of parking lot managing information 600;

FIG. 7 is an example of parking lot detailed information 700;

FIG. 8 is an example of reservation information 800;

FIG. 9 is an example of state description 900 for charging space;

FIG. 10 is an example of state information 1000;

FIG. 11 is an example of telemetry information 1100;

FIG. 12 is an example of command information 1200;

FIG. 13 is an example of configuration information 1300;

FIG. 14 is an example of a plan view of a charging space 1400;

FIG. 15 is a schematic diagram illustrating (A) a regulation release state and (B) a regulation state of a regulation device according to one embodiment;

FIG. 16 is an example of a reservation managing flow 1600;

FIG. 17 is an example of a reservation receiving flow 1700;

FIG. 18 is an example of an entering processing flow 1800;

FIG. 19 is an example of a charging/leaving/reservation completing processing flow 1900;

FIG. 20 is another example of a reservation receiving flow 2000;

FIG. 21 is another example of a charging/leaving/reservation completing processing flow 2100;

FIG. 22 (A) to (C) are examples of a touch panel display of a charger;

FIG. 23 is an example of a state transition diagram 2300;

FIG. 24 is an example of a state managing flow 2400;

FIG. 25 is an example of a state managing flow 2500;

FIG. 26 is an example of a time billing flow 2600;

FIG. 27 is an example of a reservation screen 2700;

FIG. 28 is an example of a reservation screen 2800;

FIG. 29 is an example of a reservation screen 2900;

FIG. 30 is an example of a selection receiving screen 3000 for the reservation mode;

FIG. 31 is an example of a confirmation screen 3100;

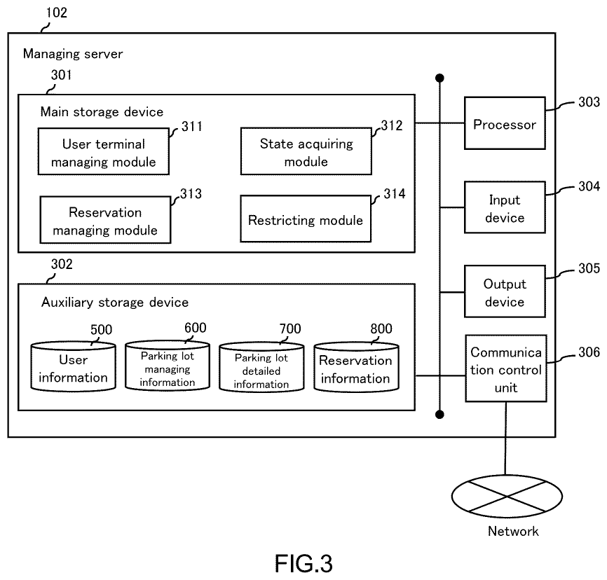

FIG. 3 is an example of a reservation confirmation screen 3200;

FIG. 33 is an example of a check-in screen 3300;

FIG. 34 is an example of a charging state display screen 3400;

FIG. 35 is an example of a temporarily leaving state display screen 3500; and

FIG. 36 is an example of a use completion screen 3600.

### DESCRIPTION OF EMBODIMENTS

Hereinafter, embodiments will be described in detail with referring to the figures. In the respective figures, reference numerals and redundant descriptions will be omitted for configurations having the same functions.

### First Embodiment

### Reservation Managing System

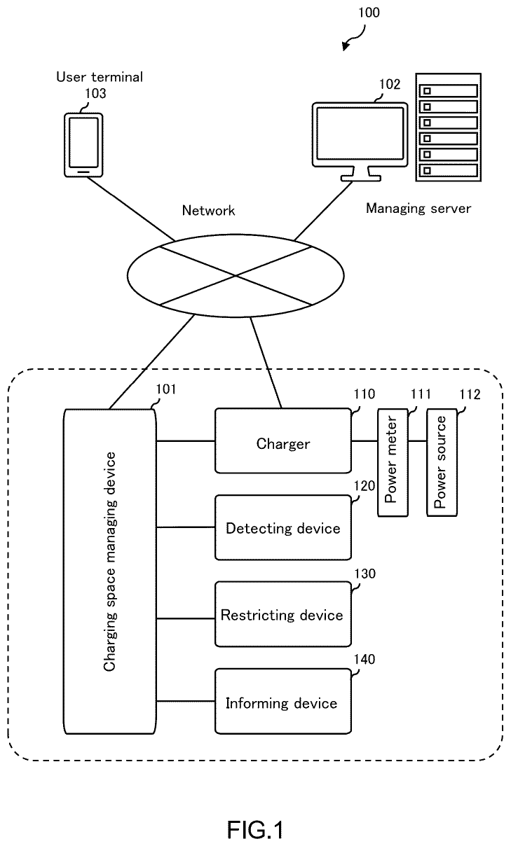

FIG. 1 illustrates an example of a whole configuration of a reservation managing system 100 according to one embodiment. The reservation managing system 100 related to the present technology is configured as a system for managing a utilization reservation (hereinafter, simply referred to as “reservation”) of a parking space (which is a space for performing charging) provided with a charger to be used with an electric vehicle (or EV), a plug-in hybrid vehicle (or PHV), and the like.

The reservation managing system 100 includes one or a plurality of charging space managing devices 101, one or a plurality of managing servers 102, and one or a plurality of user terminals 103. The managing server 102 is one example of a reservation managing device according to the present technology. One or a plurality of the charging space managing devices 101 and one or a plurality of the user terminals 103 are respectively configured to be capable of being connected to one or a plurality of the managing servers 102 via a network. Each terminal is capable of transmitting and receiving information via the network, regardless of whether the network is wired or wireless.

For example, the charging space managing device 101, the managing server 102, and the user terminal 103 included in the reservation managing system 100 may, respectively, be a portable terminal (or mobile terminal) such as a smartphone, a tablet, a mobile phone, or a personal digital assistant (or PDA); or a wearable terminal such as a glasses-type wearable terminal, a head-mounted type wearable terminal, a wristwatch-type wearable terminal, or a clothing-type wearable terminal. Also, the above-mentioned devices may, respectively, be a stationary type computer, a portable type computer, or a server located on a cloud or network. In addition, from a point of view of the functions thereof, the above-mentioned devices may, respectively, be a VR (or Virtual Reality) terminal, an AR (or Augmented Reality) terminal, or a MR (or Mixed Reality) terminal. Alternatively, a combination of a plurality of the terminals may be used for any of the above-mentioned devices. For example, a combination of one smartphone and one wearable terminal may logically function as one terminal. Furthermore, other information processing terminals may be used for any of the above-mentioned devices.

The terminals of the reservation managing system 100 respectively includes a processor for executing an operating system, an application, a program, and the like; a main storage device such as a RAM (Random Access Memory); an auxiliary storage device such as an IC card, a hard disk drive, an SSD (Solid State Drive), and a flash memory; a communication control unit such as a network card, a wireless communication module, and a mobile communication module; an input device such as a touch panel, a keyboard, a mouse, a voice input device, and an input device by motion detection based on images obtained from a camera unit; and an output device such as a monitor, a display, a printer, a voice output device, and an oscillator. The input device may be provided with a sensor such as a GPS, a gyro-sensor, or an accelerometer. The output device may be a device or a terminal for transmitting information to be outputted to an external monitor, a display, a printer, a device, or the like.

Various programs, applications, and the like (for example, software modules) are stored in the main storage device, and it is configured such that when the processor executes any one of the programs and applications, each functional element of the entire system is realized. Each module may be an independent program or application, but may also be implemented as a form of a subprogram or function of one part of an integrated program or application. Each of these modules may be implemented as a hardware (such as hardware module) by integrating a circuit or employing a microcomputer. Further, each of these modules may be provided in a single terminal (including a managing server), or may be provided separately in two or more terminals (including a managing server) which are mutually connected via a network.

In the present specification, each module is described as a subject that performs processes, but in practice, it is conceivable that a processor that executes various programs, applications, and the like performs the processes.

Various databases (DB) are stored in the auxiliary storage device. The “database” means one or a plurality of data sets that are collected and organized to accommodate arbitrary data manipulation (for example, extracting, adding, deleting, and overwriting of data) by a processor or external computer. The auxiliary storage device is a functional element (or storage unit) that stores one or a plurality of data sets. The way of implementing of the database is not limited, and may be, for example, performed by use of a database management system, a spreadsheet software, or a text file such as XML and JSON.

### Charging Space Managing Device

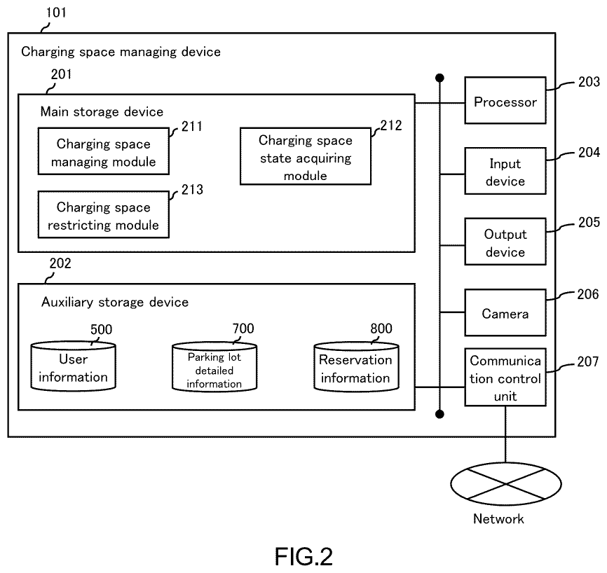

FIG. 2 illustrates a hardware configuration of a charging space managing device 101.

The charging space managing device 101 is an element capable of managing use states of one or a plurality of spaces for performing charging. For example, the charging space managing device 101 may be configured by a microcomputer or the like. The charging space managing device 101 includes a main storage device 201 and an auxiliary storage device 202. In addition, the charging space managing device 101 includes a processor 203, an input device 204, an output device 205, a camera 206, and a communication control unit 207, as described above.

The main storage device 201 stores programs and applications such as a charging space managing module 211, a charging space state acquiring module 212, and a charging space restricting module 213. It is configured such that when the processor 203 executes any one of the programs and applications stored in the main storage device 201, each functional element of the charging space managing device 101 is realized.

The auxiliary storage device 202 stores information necessary for the operations of the reservation managing system 100. For example, the auxiliary storage device 202 stores user information 500, parking lot detailed information 700, reservation information 800, and the like. Details of these pieces of information will be described later. These pieces of information may be some or all of information relating to the charging space managing device 101 among the user information 500, the parking lot detailed information 700, the reservation information 800, and the like stored in the managing server 102.

Hereinafter, each functional element of the charging space managing device 101 will be described together with the configuration of the charging space 1400.

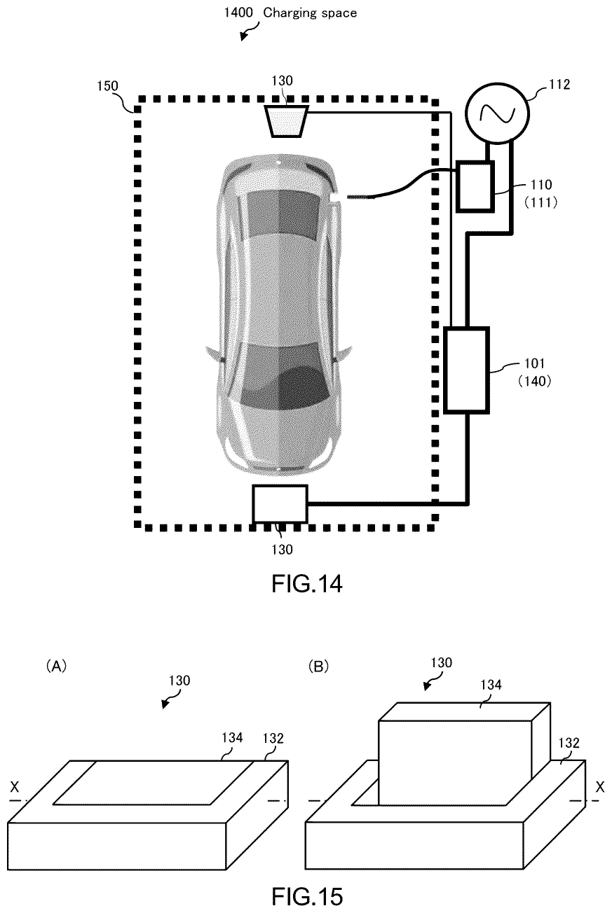

FIG. 14 illustrates an example of a plan view of a charging space (or a space for performing charging) 1400. As illustrated in FIGS. 1, 2, and 14, the charging space 1400 is provided with a parking area 150 capable of parking an electric vehicle, a charging space managing device 101, a charger 110, a detecting device 120, a restricting device 130, and an informing device 140. In this example, the charger 110 is provided with a power meter 111 and is connected to an external power source 112 via the power meter 111. The charging space managing device 101 is connected to each of the charger 110, the detecting device 120, the restricting device 130, and the informing device 140 by a wired or wireless connection, and the charging space managing device 101 is configured to be capable of transmitting and receiving information to and from each of these devices.

It is conceivable that any of various types of chargers capable of supplying electric power to an electric vehicle (more specifically, a power source for driving an electric vehicle) may be used as the charger 110, without particular restrictions. For example, the charger 110 may be a normal charger having a rated output of less than about 10 kW (for example, in a range of from 3 to 6 kW), or may be a quick charger (or rapid charger) having a rated output of more than about 10 kW (for example, 50 kW). The charger 110 according to the present example may be configured to be switched between a chargeable state (or a state in which charging is enabled) and a non-chargeable state (or a state in which charging is not enabled) under the condition of turning on the main power supply. The configuration (for example, a changeover switch) for switching the states of the charger 110 between the chargeable state and the non-chargeable state may be one example of the restricting device which is configured to restrict the use of the charging space.

The detecting device 120 is configured to detect presence or absence of a vehicle in the parking area 150. As the detecting device 120, for example, any one or a combination of at least two of various types of vehicle detectors such as an infrared sensor, an ultrasonic sensor, a loop coil sensor, and a vehicle recognition imaging system may be used. FIG. 14 illustrates one example in which an infrared sensor capable of being easily retrofitted to an existing charging space is used as the detecting device 120. For example, the detecting device 120 is configured to detect presence or absence of a vehicle in the parking area 150 at a predetermined time interval (typically, every 1 to 60 seconds, for example, every 10 seconds, depending on the detecting mechanism). The detection result from the detecting device 120 is acquired by the state acquiring module 312 of the charging space managing device 101, or is transmitted to the charging space managing device 101 from the detecting device 120. In FIG. 14, one example of installing the detecting device 120 on the back side of the parking area 150 is illustrated. However, it is possible to install the detecting device 120 on the entrance side, the lateral side, the upper side, the lower side (including the slab) or the like of the parking area 150, depending on the detection characteristics of the detecting device 120.

The restricting device 130 is an element capable of preventing a vehicle from entering into the parking area 150. FIG. 15 illustrates a schematic diagram of the restricting device 130 according to one embodiment. The restricting device 130 includes a main body 132 and a plate-shaped restricting member 134 that is pivotally supported by the main body. The restricting member 134 is configured to rotate about an X-axis along the plate surface. The restricting device 130 is disposed on the entrance side of the parking area 150, and when it is in the restriction releasing state (A), the restricting member 134 is made to be in a horizontal posture so that a vehicle is allowed to enter into the parking area 150, and when it is in the restricting state (B), the restricting member 134 is made to be raised so that it becomes possible to prevent the entrance of a vehicle into the parking area 150.

The informing device 140 is an additional configuration of the reservation managing system 100 and is an element capable of informing or warning the use state of the charging space. The informing device 140 may be any one of or both of a displaying device such as a display, a LED lamp, and a rotatable-flap display which are each capable of visually informing the use state; and a sound informing device such as a speaker which is capable of audibly informing. In the present example, the informing device 140 is a LED displaying device, and is configured to display various use states by, for example, its light emission color (in this example, red or green), its light emission mode (for example, lighting, extinguishing, blinking, or the like), a character display, or the like.

The charging space state acquiring module 212 of the charging space managing device 101 is capable of acquiring information indicating presence or absence of a vehicle, detected by the detecting device 120, at a predetermined cycle (for example, every 100 to 500 milliseconds or the like). The charging space state acquiring module 212 stores the information indicating presence or absence of a vehicle obtained by the detecting device 120 in the auxiliary storage device 202.

The charging space managing module 211 is capable of transmitting the information on presence or absence of a vehicle obtained by the charging space state acquiring unit to the managing server 102 at a predetermined cycle (for example, per every ten of seconds). In addition, the charging space managing module 211 may transmit information on the use state of the charging space to the managing server 102 at a timing requested from the managing server 102. Further, when the charging space managing module 211 receives an instruction regarding the information content for the informing device 140 (typically, information of the use state of the charging space) from the managing server 102, the charging space managing module 211 outputs the information content (or instruction) to the informing device 140.

The charging space restricting module 213 is capable of putting the restricting device 130 provided in the charging space into a state for restricting the use of the charging space or into a state for releasing the restriction. For example, the charging space restricting module 213 outputs information (or instruction) to the restricting device 130 so as to put it into a state (A) for enabling the entering of a vehicle, or into a state (B) for preventing the entrance of a vehicle. In addition, the charging space restricting module 213 is capable of outputting information (or instruction) to the charger 110 so as to switch it between the chargeable state and the non-chargeable state.

In FIG. 14, it is illustrated that the informing device 140 is integrally provided in the charging space managing device 101. However, the informing device 140 may be provided integrally with the charger 110 or with the restricting device 130, or may be provided independently at a position capable of being easily viewed from a user, for example, at an entrance side or an upper rear side of the parking area 150. Further, the charging space managing device 101, the charger 110, the detecting device 120, the restricting device 130, and the informing device 140 may, respectively, be provided independently, or any two or more of them may be integrally provided.

### Managing Server

FIG. 3 illustrates a hardware configuration of a managing server 102.

The managing server 102 is an element capable of managing the reservation managing system 100 of the present embodiment. For example, the managing server 102 is constituted by a server arranged on a cloud. The managing server 102 is provided with a main storage device 301 and an auxiliary storage device 302. The managing server 102 is also provided with a processor 303, an input device 304, an output device 305, and a communication control unit 306, as described above.

The main storage device 301 stores programs and applications such as a user terminal managing module 311, a state acquiring module 312, a reservation managing module 313, and a restricting module 314, and it is configured such that when the processor 303 executes any one of the programs and applications stored in the main storage device 301, each functional element of the managing server 102 is realized.

The auxiliary storage device 302 stores information necessary for the operations of the reservation managing system 100. For example, the auxiliary storage device 302 stores the user information 500, the parking lot managing information 600, the parking lot detailed information 700, the reservation information 800, and the like. Details of these pieces of information will be described later.

Hereinafter, the respective functional elements of the managing server 102 will be described.

The user terminal managing module 311 is configured to manage the operations of the user terminal 103. The user terminal managing module 311 cooperates with the user executing module 411 of the user terminal 103 to control basic operations for reserving and using a charging space which are executed by use of the reservation managing system 100 in the user terminal 103.

For example, the user terminal managing module 311 cooperates with the user executing module 411 to output (or display) a login page for accessing to a charging space reservation site provided by the managing server 102, a user information management page, and the like, on the output device 405 such as a display of the user terminal 103. In addition, the user terminal managing module 311 cooperates with, for example, the user executing module 411 of the user terminal 103 to acquire input information inputted from the user terminal 103 via any of these pages. For example, the user terminal managing module 311 functions based on the acquired information (such as various types of information, instructions, and the like), and outputs (or stores) the acquired information in the auxiliary storage device 302, as the user information 500 or the like.

The state acquiring module 312 acquires information relating to presence or absence of a vehicle in the charging space. The state acquiring module 312 typically acquires information indicating presence or absence of a vehicle, sent from the charging space state acquiring module 212 of the charging space managing device 101. In other words, the state acquiring module 312 monitors information relating to presence or absence of a vehicle in the charging space via the charging space managing device 101 (and the detecting device 120). For example, the acquired information is stored in the auxiliary storage device 302.

The reservation managing module 313 is an element capable of accepting a reservation for a charging space according to the use state of the charging space. The reservation managing module 313 determines whether the use state of the charging space is a reservation available state based on information acquired by the state acquiring module 312 from the user terminal 103. Then, if it is a reservation available state, the reservation managing module 313 accepts a reservation for the charging space. Specific operations of the reservation managing module 313 will be described later.

In the present specification, the reservation available state is expressed in that accepting a reservation is enabled. This state is identical with the “usable state” which will be described later. For example, the technical term, “usable” is interchangeable with “reservation available”.

The restricting module 314 is configured to manage the use states of the charging space. When the reservation managing module 313 accepts a reservation for the charging space, the restricting module 314 puts the restricting device 130 provided in the charging space into a state for restricting the use of the charging space. For example, the restricting module 314 controls the state of the restricting device 130 via the charging space managing module 211. Specific operations of the restricting module 314 will be described later.

### User Terminal

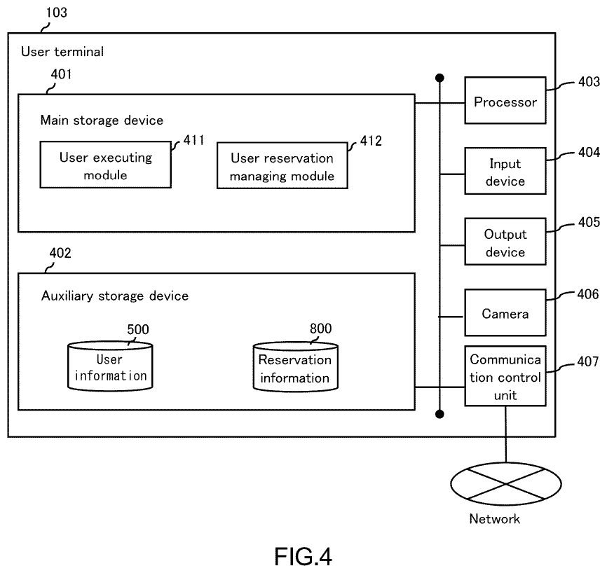

FIG. 4 illustrates an example of a hardware configuration of a user terminal 103. The user terminal 103 is a terminal to be operated by a user using the reservation managing system 100, and may be composed of, for example, a terminal such as a smart phone, a tablet, a notebook PC, or a desktop PC. The user terminal 103 is provided with a main storage device 401 and an auxiliary storage device 402. The user terminal 103 is also provided with a processor 403, an input device 404, an output device 405, a camera 406, and a communication control unit 407, as described above.

The main storage device 401 stores programs and applications such as a user executing module 411 and a user reservation managing module 412, and it is configured such that when the processor 403 executes any one of the programs and applications, each functional element of the user terminal 103 is realized

The user executing module 411 controls basic operations of the user terminal 103 at the time of using the reservation managing system 100. For example, the user executing module 411 cooperates with the user terminal managing module 311 of the managing server 102 in order to control basic operations for reserving and using the charging space, by use of the reservation managing system 100.

For example, the user executing module 411 cooperates with the user terminal managing module 311 of the managing server 102 to output (or display) a predetermined displaying screen such as a login page of an application for making a reservation (hereinafter, simply referred to as “application”) of the charging space, and a surrounding map of the current location, on the output device 305 such as the display of the user terminal 103.

The user reservation managing module 412 is capable of receiving (or accepting) an input relating to the reservation and the utilization of the charging space from a user. For example, the user reservation managing module 412 cooperates with the user terminal managing module 311 of the managing server 102 to transmit the input information inputted by a user via the display screen or the input device 304, such as information on the charging space for which a reservation is desired to be made, to the managing server 102.

The auxiliary storage device 402 stores information necessary for the operations of the user terminal 103. The auxiliary storage device 402 stores, for example, the user information 500, the reservation information 800, and the like. These pieces of information may be some or all of the information relating to the user terminal 103 among the user information 500, the reservation information 800 and the like, stored in the managing server 102.

From FIG. 5 to FIG. 8 various types of information stored in the managing server 102 are illustrated. Some or all of these pieces of information are assumed to be stored as JSON format file, but are not limited thereto. Some or all of these pieces of information may be configured to be stored in a relational database or a non-relational database.

FIG. 5 illustrates an example of the user information 500.

The user information 500 is information relating to a user using the reservation managing system 100. The user information 500 includes, for example, a user ID, a user display ID, a user name, an address, payment information, password information, personal identification information such as a login ID, and the like, and values exemplified by sample values 520 are respectively inputted to the field names 510.

The user ID is a symbol assigned to each user for identifying the user, and is automatically generated as a hash-value or the like. Information relating to each user is basically associated by the user ID. The user display ID is an ID for displaying a user on a display of the managing server 102, the user terminal 103, or the like, and may be arbitrarily set. The user's name, the address, and the payment information, are respectively correspondent to information relating to the name, the address, and the fee payment with respect to the user (which may be a natural person or a corporation; the same applies to the following). The personal identification information is authentication information for performing login to a reservation application for making a reservation for a charging space and for using it, or for performing a confirmation of the identity of the user, and is not limited to the password information, the login ID, and the like.

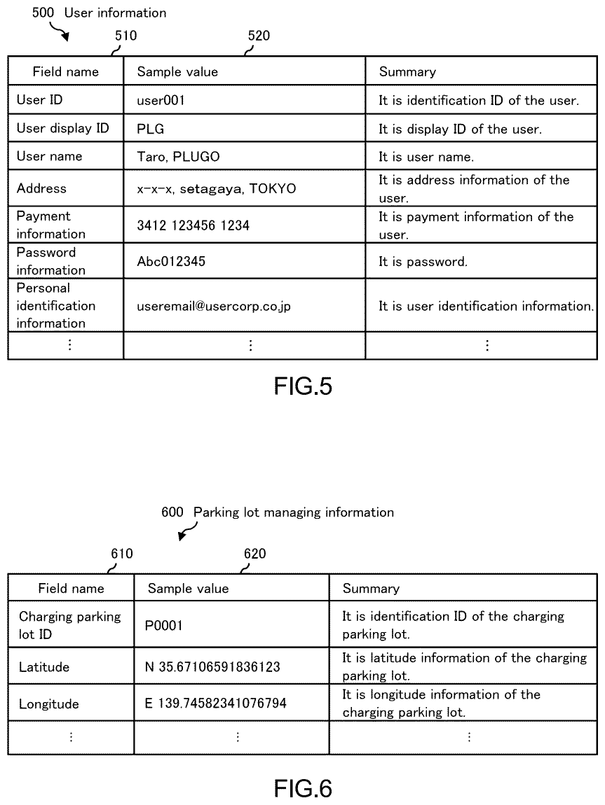

FIG. 6 illustrates an example of the parking lot managing information 600.

The parking lot managing information 600 may be information for retrieval regarding a charging space (which may be a parking lot capable of performing charging, having one or a plurality of charging spaces) registered in the reservation managing system 100. For example, the parking lot managing information 600 includes information on the charging parking lot ID and information on the latitude and longitude thereof as position information of the charging parking lot, and values exemplified by sample values 620 are respectively inputted corresponding to the field names 610. The charging parking lot ID is a symbol assigned to each charging parking lot for identifying the charging parking lot, and is automatically generated as a hash-value or the like. The position information is information for representing the position of the charging parking lot, and typically includes information regarding the latitude and longitude thereof. The position information may include other information such as the altitude thereof, or may be provided as other display formats such as simple position information, relative position information, or the like.

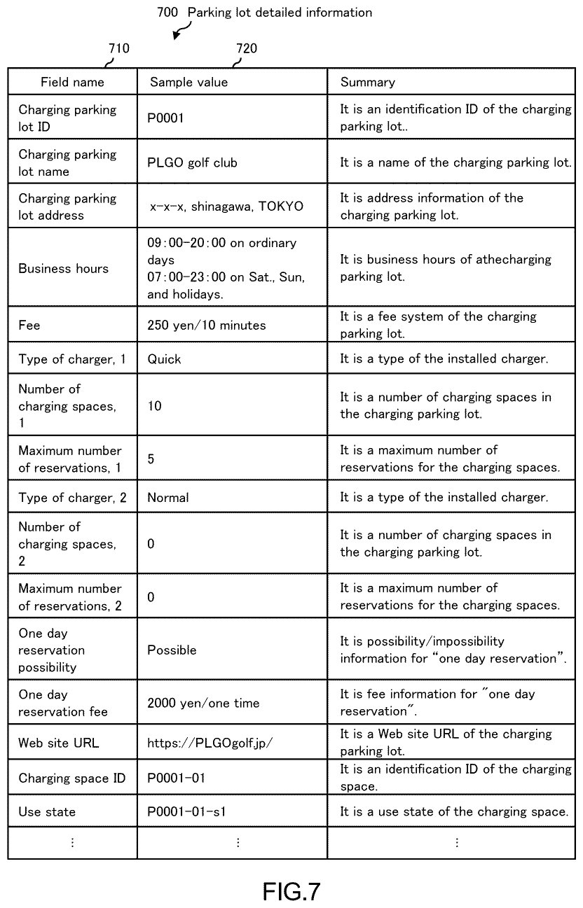

FIG. 7 illustrates an example of the parking lot detailed information 700.

The parking lot detailed information 700 includes detailed information regarding the charging parking lot which is registered in the reservation managing system 100, and the parking lot detailed information 700 is associated with the parking lot managing information 600 by the charging parking lot ID. For example, the parking lot detailed information 700 includes information such as a charging parking lot ID, a charging parking lot name, a charging parking lot address, business hours, a fee, a number of charging spaces, a type of charger, a maximum number of reservations (or a number of available reservations), a one day reservation possibility, a one day reservation fee, a website URL, a charging space ID, a use state, and the like, and values exemplified by sample values 720 are respectively inputted corresponding to the field names 710.

The number of charging spaces is the total number of the charging spaces provided in each charging parking lot. The type of charger, the number of charging spaces, and the maximum number of reservations respectively correspond to the type of the charger installed in the charging space of each charging parking lot, the number of the chargers, and the maximum number for making a reservation for it. The maximum number of reservations may be understood as the number of charging spaces of which use states are the usable state (X1) (which will be described later) for each charging parking lot. As the type of charger, typically, there are a quick charger and a normal charger, and each type includes information regarding the total number of the installations and the maximum number of reservations. The one day reservation possibility and the one day reservation fee respectively indicate the possibility of making a reservation on a daily basis and its reservation fee. The charging space ID is an ID for identifying each charging space in each charging parking lot, and is automatically generated according to information regarding the number of charging spaces. The use state is information indicating the use state of each charging space, and is sequentially determined and recorded by the reservation managing module 313 based on information regarding the charging space acquired by the managing server 102.

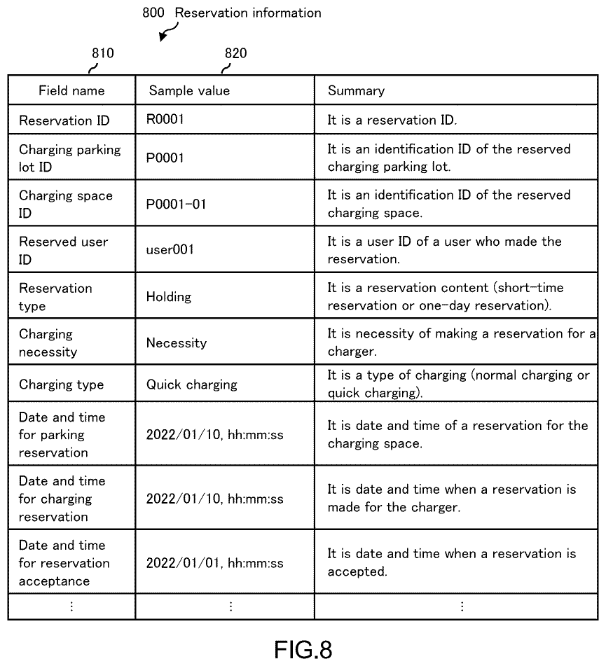

FIG. 8 illustrates an example of the reservation information 800.

The reservation information 800 is information relating to a reservation for a charging space received by the managing server 102. The reservation information 800 includes, for example, information such as a reservation ID, a parking lot ID, a parking space ID, a reserved user ID, a reservation type, a charging necessity, a charging type, a date and time for parking reservation, a date and time for charging reservation, and a date and time for reservation acceptance, and values exemplified by sample values 820 are respectively inputted corresponding to the field names 810.

The reservation ID is a symbol assigned to each reservation for identifying the reservation content, and is automatically generated as a hash-value or the like, as a primary key that is referred from other information. The parking lot ID indicates the reserved charging parking lot. The parking space ID indicates the reserved charging space of the charging parking lot, and is determined by the managing server at the time of making the reservation. The reserved user ID is a user ID of a user who made the reservation. The reservation type represents a reservation form of the charging space in the reservation service. In this example, it is possible to select either one of “one-day reservation” for making a reservation on a daily basis and of “short-time reservation” for making a reservation for up to one hour. Here, the unit of time of the daily basis may be equivalent to 24 hours or an arbitrary prescribed time length, for example, 27 hours or the like. Time interval for the short-time reservation may be set to a relatively short time, for example, in a range of from 30 minutes to 3 hours. The charging necessity is information indicating whether the charger is used (or its use is enabled) in the charging space, and the charging type indicates the type of the charger 110 to be used when the charger is used. The charging type may be selected when a normal charger(s) and a quick charger(s) are installed in one charging parking lot. Alternatively, when only one type of a normal charger(s) and a quick charger(s) is installed in one charging parking lot, the type of the charger installed therein may be automatically recorded or the recording of the type of the charger does not have to be made. The date and time for the parking reservation is information regarding the date and time for making the reservation of the charging space. The date and time for the charging reservation is information regarding the date and time for making the reservation of the charger. And, the date and time of the reservation acceptance is information regarding the date and time when the managing server 102 receives the reservation.

Hereinafter, a way of making a reservation for a charging space in a charging parking lot by use of the reservation managing system 100 will be described.

The charging parking lot for which a reservation can be made is, for example, a charging parking lot provided in a common-use facility such as a shopping mall or a sports facility, etc. As a way of using a charging space, there are a case of “using it at the site” without making a reservation and a case of “using it with a reservation” after making a reservation. As the form of the reservation, there are a case of “one day reservation” for making a reservation on a daily basis and a case of “short-time reservation” for making a reservation up to one hour. In a case when the “short-time reservation” is made, it is possible to reserve a charging space, for example, in a neighboring sports facility even if staying at home, and it is possible to secure a parking lot at the time of visiting the sports facility, and also to charge a vehicle during use of the sports facility. In the case of the “using it at the site” without making a reservation, it is supposed that a vehicle without having a reservation enters in a charging space for which a reservation is not made, in order to park there and to perform a charging operation at the site. Further, in the present embodiment, when charging is performed using the quick charger, it is assumed that time billing (or billing based on the time) is performed.

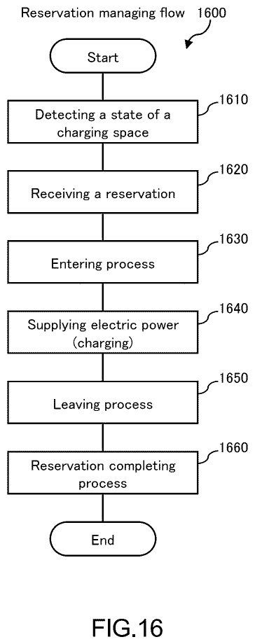

FIG. 16 illustrates an example of a reservation managing flow 1600. The reservation managing system 100 typically performs processes for reserving and managing a charging space according to the respective steps (such as from step 1610 to step 1660) of the reservation managing flow 1600. Hereinafter, the step is abridged, for example, “step 1610” is written as “S1610”.

### Detecting a State of a Charging Space (S1610)

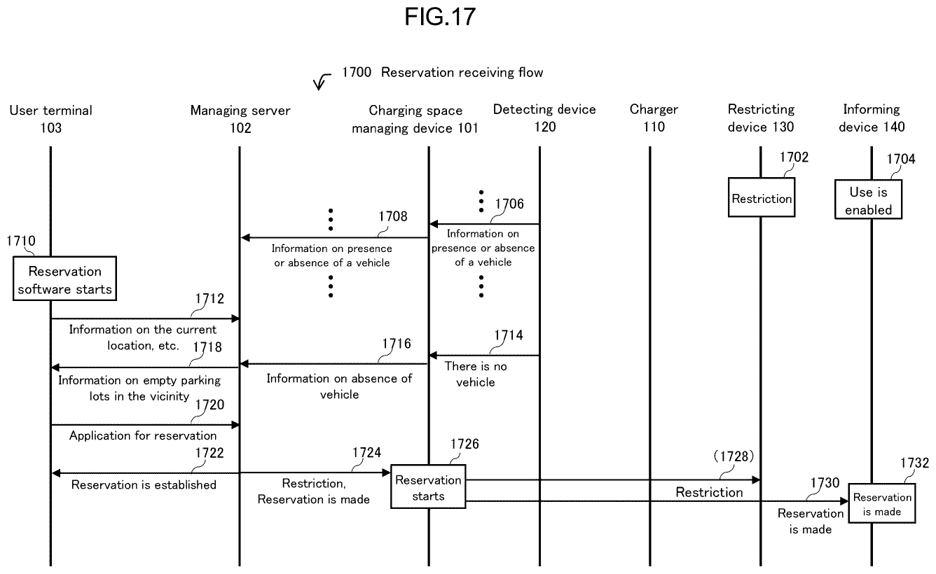

FIG. 17 illustrates an example of a reservation receiving flow 1700.

In the first embodiment, the restricting device 130 provided in each charging space is put into a restricting state for preventing a vehicle from entering therein when no reservation is made

(S1702), and the informing device 140 indicates that the charging space is enabled to be used (S1704). In each charging space, the detecting device 120 detects presence or absence of a vehicle in the charging space at a predetermined time interval. For example, the charging space state acquiring module 212 acquires information on presence or absence of a vehicle obtained by the detecting device 120 at a predetermined cycle (S1706). For example, the charging space managing module 211 transmits information acquired by the charging space state acquiring module 212 to the managing server 102 at a predetermined time interval (for example, every 20 seconds) (S1708). The state acquiring module 312 of the managing server 102 acquires information on presence or absence of a vehicle, and for example, records the information in the auxiliary storage device 302. Accordingly, the reservation managing module 313 is capable of recognizing presence or absence of a vehicle in each charging space. The state acquiring module 312 may detect the use states, for example, during the business hours, for the respective charging parking lots. Details of the use states will be described later.

### Reservation Receiving Process (S1620)

A user who wants to make a reservation for a charging space, at first, starts a reservation software (or a reservation application) on the side of the user terminal 103 (S1710). This leads to the connection to the managing server 102 by the user executing module 411 of the user terminal 103. The user terminal managing module 311 of the managing server 102 cooperates with the user executing module 411 and the like of the user terminal 103 to execute a process such as a login operation of the user.

It is conceivable that there are various ways of reserving a charging parking lot. For example, there is a way of designating a charging parking lot for which making a reservation is enabled from among charging parking lots close to the current location of the user terminal 103. In such a case, the user executing module 411 transmits the current location of the user terminal 103 to the managing server 102 (S1712). Accordingly, the reservation managing module 313 of the managing server 102 displays, on the output device 405 such as a display of the user terminal 103, map information of the surroundings of the current location and information regarding the charging parking lots for which making a reservation is enabled, existing in the map. The charging parking lot for which making a reservation is enabled is a charging parking lot to which it is determined that the maximum number of reservations is bigger than zero, at the time of representing the information, by acquiring information indicating absence of a vehicle by the detecting device 120 (S1714, S1716). The management of the maximum number of reservations will be described later.

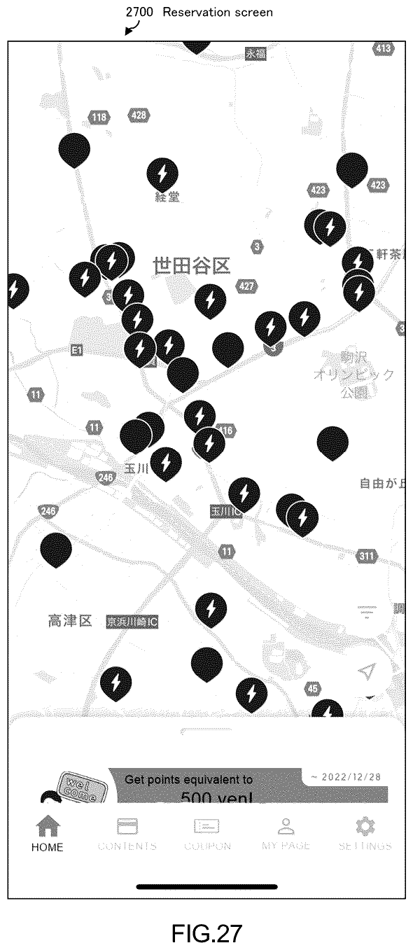

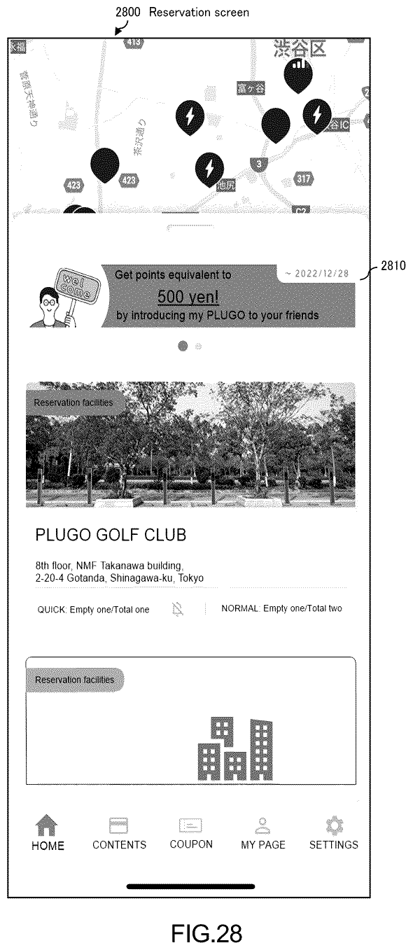

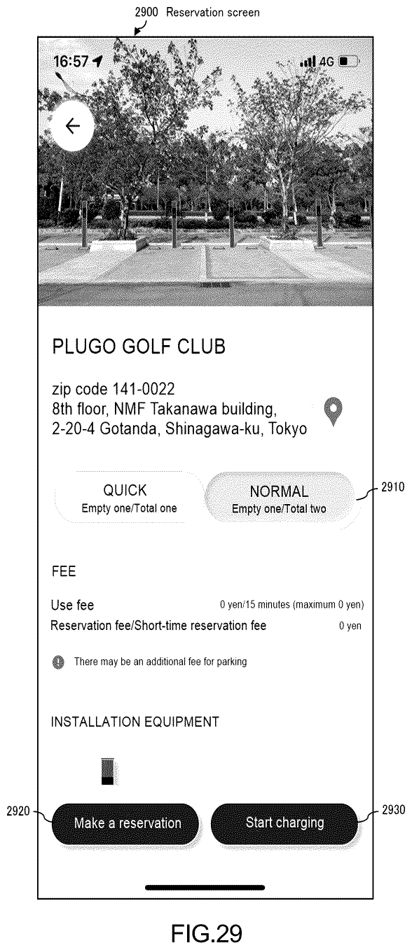

FIG. 27 illustrates an example of a reservation screen 2700. Each circular mark (which is showing a charging parking lot) displayed in the map of the reservation screen 2700 indicates a position of a charging parking lot for which making a reservation is enabled. For example, the user terminal managing module 311 displays a mark having a lightning shape in a charging parking lot mark for indicating that the charging parking lot is provided with a quick charger. In addition, the user terminal managing module 311 is capable of receiving a selection of a charging parking lot mark displayed on the display via the user terminal 103. As a result, for example, as illustrated in FIG. 28, a simple information window 2810 for the selected charging parking lot is made to be displayed on the surrounding map. For example, the simple information window 2810 displays simple information on the charging parking lots in the neighborhood in addition to the selected charging parking lot. Accordingly, for example, in a case where the conditions of the selected charging parking lot do not satisfy the user's desire, the user is allowed to easily obtain information on the charging parking lots in the vicinity. When the user terminal managing module 311 receives a selection of a charging parking lot for which a reservation is desired to be made from among the charging parking lots displayed on the simple information window 2810, the user terminal 103 is made to display a reservation screen 2900 of the charging parking lot, as illustrated in FIG. 29.

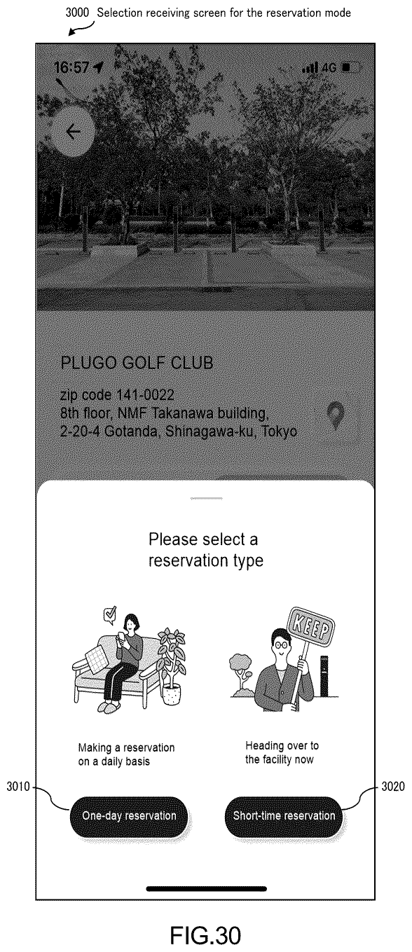

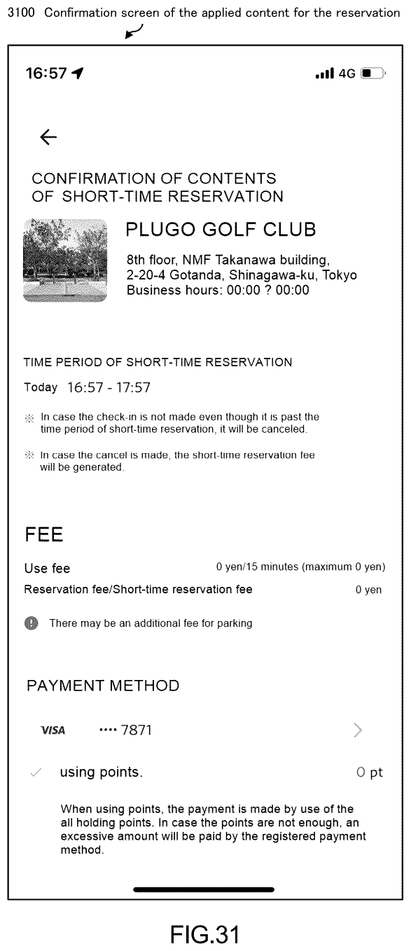

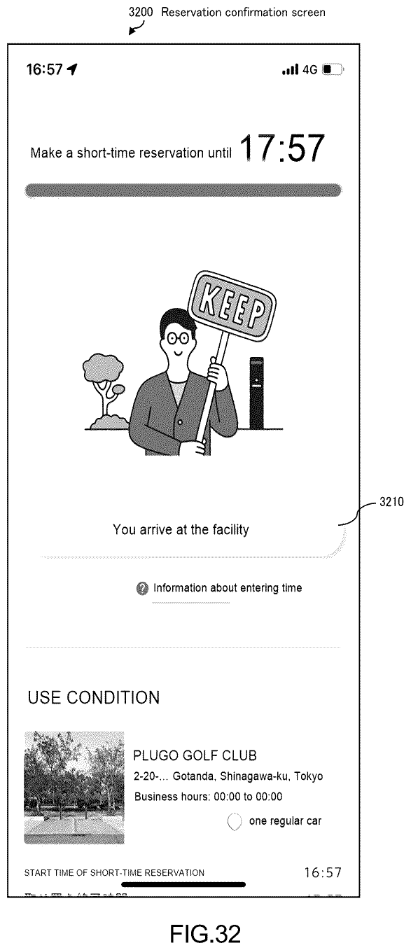

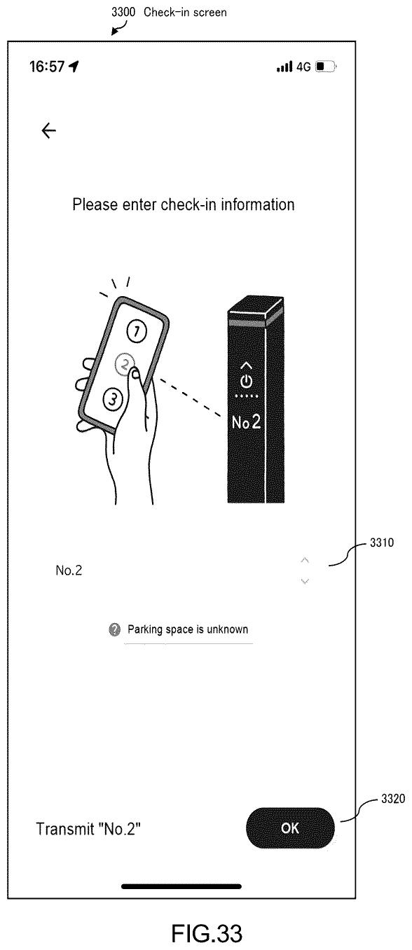

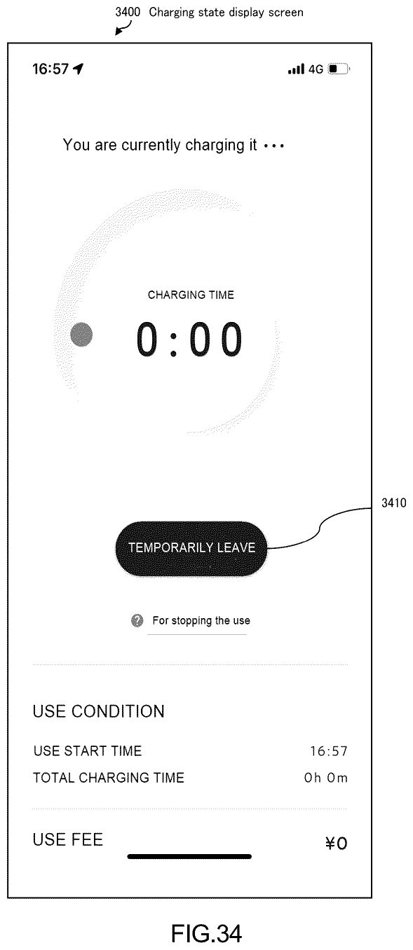

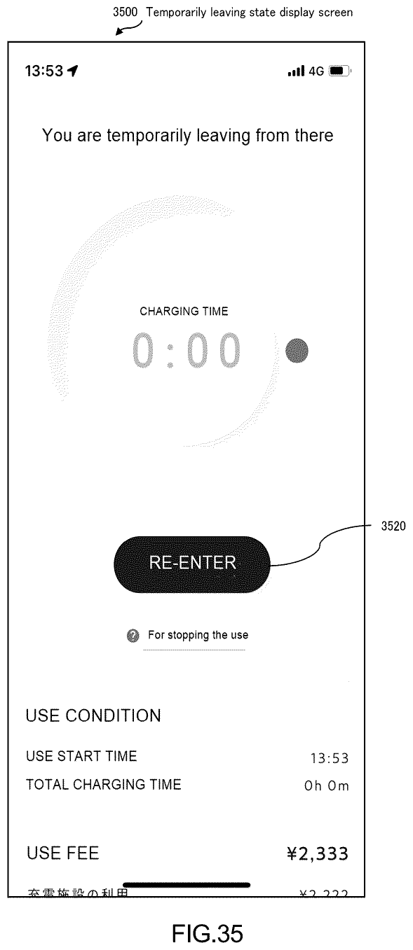

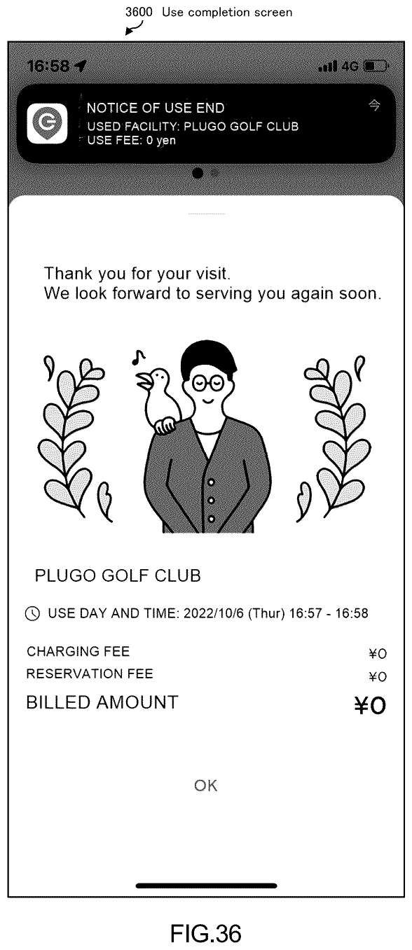

The user terminal managing module 311 displays, for example, a charging type selection button 2910, a reservation button 2920, and a charging start button 2930 on the reservation screen 2900. The user selects the reservation button 2920 when making a reservation for the charging parking lot, or selects the charging start button 2930 when performing the charging operation immediately without making a reservation. When the user terminal managing module 311 accepts the selection of the charging type and the selection of the reservation button 2920 through the user terminal 103, for example, subsequently, the user terminal managing module 311 displays a selection receiving screen 3000 for the reservation mode, on the user terminal 103, as illustrated in FIG. 30. The user terminal managing module 311 displays a one day reservation selection button 3010 and a short-time reservation selection button 3020 on the selection receiving screen 3000 of the reservation mode. Accordingly, when receiving the selection of either one of the two buttons 3010, 3020, the user terminal managing module 311 displays a confirmation screen 3100 of the applied content for the reservation, as illustrated in FIG. 31. When the confirmation screen 3100 illustrated in FIG. 31 is scrolled down, a reservation button is made to be displayed. Then, for example, when receiving the selection of the reservation button, the user terminal managing module 311 accepts an application for a reservation for the selected charging type and the reservation mode with respect to the selected charging parking lot (S1720). In this example, an application for a short-time reservation with a quick charging is accepted.

In a case where the maximum number of reservations of the charging parking lot is bigger than zero at the time of accepting the application for reservation, the reservation is established, and the reservation managing module 313 transmits information indicating that the reservation is established to the user terminal 103 (S1722). The reservation managing module 313 outputs, for example, a reservation confirmation screen 3200 to the user terminal 103, as illustrated in FIG. 32. As a result, for example, as illustrated in FIG. 32, the charging space is kept in the reserved condition from the start of the reservation to the limit time of the short-time reservation (for example, during 60 minutes from 16:57 to 17:57). The user terminal managing module 311 displays, for example, the end time of the short-time reservation (in this example, “17:57”) on the reservation confirmation screen 3200.

When the reservation is established, the reservation managing module 313 records that the use state of the charging space has been changed from a reservation available state (or reservation-enabled state) (X1) to a reserved state (X6), which will be described later. In addition, the reservation managing module 313 transmits, to the charging space managing device 101, information indicating that the charging space is in the reserved state (X6), to be shown by the informing device 140 (S1724). In this case, the restricting device 130 is in the restricting state, and accordingly, it is not necessary to give an instruction from the managing server 102 to the restricting device so that the instruction may be omitted. On the other hand, for example, for the purpose of confirming the operations of the restricting device 130, the restricting module 314 may output, to the charging space managing device 101 corresponding to the reserved charging space of the charging parking lot, information indicating that the restricting device 130 is put into the restricting state (B) for restricting the use of the charging space. As a result, the reservation operation is started at the charging space for which the application is made (S1726). The charging space restricting module 213 outputs, to the restricting device 130, information indicating that it is put into the restricting state for restricting the use of the charging space (S1728). In addition, the charging space managing module 211 outputs, to the informing device 140, information indicating that the use state of the charging space is the reserved state (S1730). As a result, the informing device 140 outputs information indicating that the charging space is in the reserved state (S1732).

On the other hand, in a case where the maximum number of reservations of the charging parking lot is zero at the time of the acceptance, the reservation is not established, and the reservation managing module 313 transmits, to the user terminal 103, information indicating that the reservation is not established. As for the reasons of the failure of the reservation, for example, it is conceivable that the maximum number of reservations has been changed to zero due to a reservation made by another user for the charging parking lot, or due to a start of use of the charging parking lot without making a reservation. In such a case, the reservation managing module 313 displays the reservation screen 2700 or 2800 again, in order to receive an application for reservation for a different charging parking lot from the user.

### Use State Determining Process

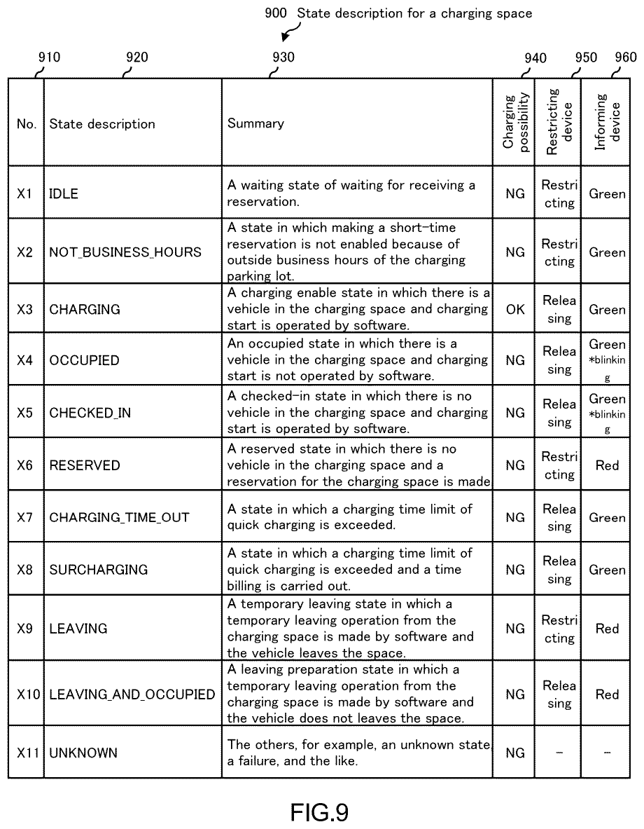

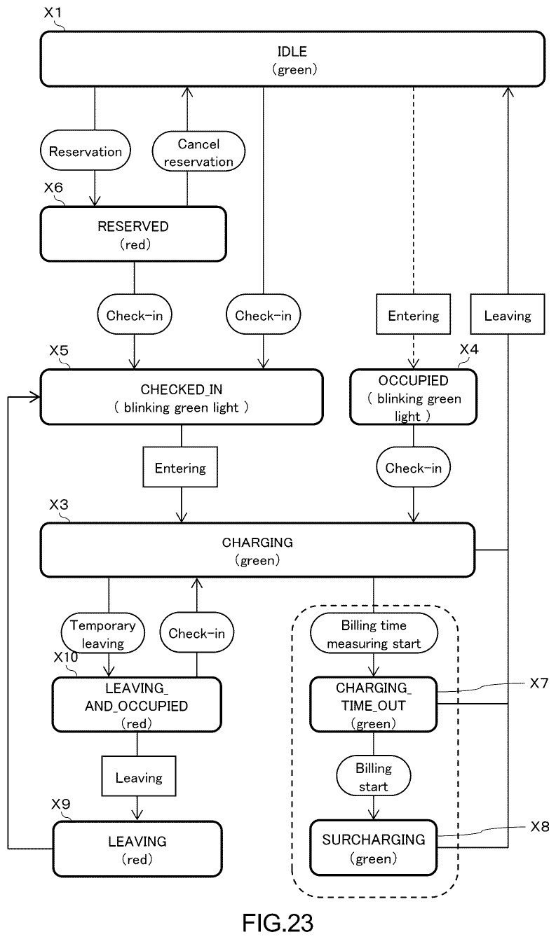

The reservation managing module 313 of the managing server 102 manages the use states of the respective charging spaces (charging space IDs), for each charging parking lot, in substantially real time. FIG. 9 illustrates an example of the state description 900 for each charging space of a charging parking lot. The state of the restricting device 130 and that of the informing device 140 are described in the state description 900. The use states of the respective charging spaces are managed by the managing server 102, for example, respectively in eleven states of from X1 to X11 as illustrated in FIG. 9. Each use state is made to have the “No.” field 910, the “state description” field 920, and the “summary” field 930 for exemplifying the content, as illustrated in the figure. The use state of the charging space is capable of being changed, for example, as illustrated in a state transition diagram 2300 of FIG. 23. The managing server 102 manages the use states of the respective charging spaces in a running condition, in a real time, for example, respectively in nine states (X1, X3 to X10), as illustrated in FIG. 23.

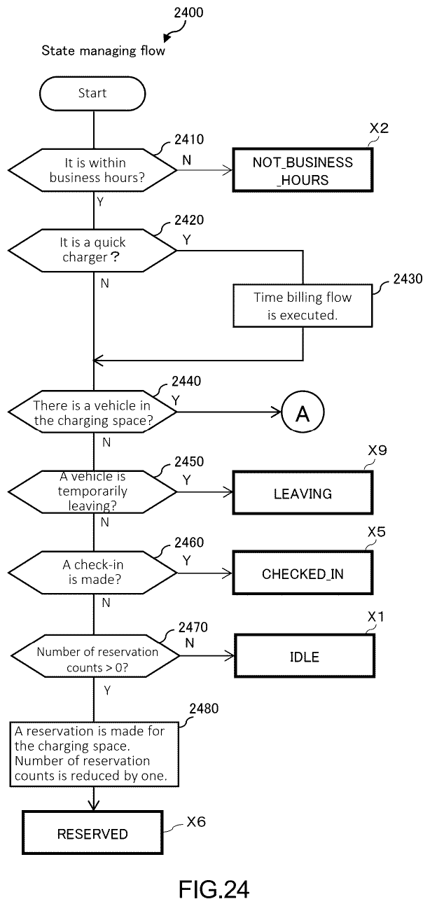

The use states of the respective charging spaces are capable of being determined, for example, according to flows 2400, 2500, and 2600 illustrated in FIGS. 24 to 26. When accepting a reservation, the reservation managing module 313 confirms the use state, according to state managing flows 2400, 2500, and 2600, in a predetermined order, for each charging space for which a reservation is applied in the charging parking lot. Accordingly, a determination may be made to decide whether a reservation can be accepted for the charging space in the charging parking lot. The order for confirming the use states with respect to the respective charging spaces in the charging parking lot is arbitrary, and for example, the order may be made from the earliest arrangement (or earliest order) of the charging space IDs (for example, the order is made from a smallest ID number).

At the time of determining the use state of the charging space, the reservation managing module 313 first determines whether the present time is within the business hours, as illustrated in the state managing flow 2400 (S2410). If the present time is not within the business hours (N at S2410), the charging space of the charge parking lot is recorded as being in a state of “Out of business hours (NOT BUSINESS HOURS)” (X2). Then, the reservation managing module 313 determines whether the type of the charger for which the reservation is applied is the quick charger (S2420). In a case where the reservation type of the charger 110 is the quick charger (Y at S2420), it is recorded that a determination whether the time billing is executed according to the time billing flow illustrated in FIG. 26 needs to be done, at the time of using the charging space (S2430).

Subsequently, the reservation managing module 313 determines whether there is a vehicle in the charging space (S2440). In a case where there is no vehicle (N at S2440), the reservation managing module 313 determines whether the vehicle is temporarily leaving therefrom (S2450). If it is temporarily leaving (Y at S2450), the reservation managing module 313 records that the use state is a state of “Temporarily leaving (LEAVING)” (X9). Alternatively, in a case where it is not temporarily leaving (N at S2450), the reservation managing module 313 determines whether a check-in has been made (S2460). Here, the “check-in” means that the charger 110 installed in the charging space is permitted to be used. The check-in may be made by executing a check-in operation, which will be described later. If the check-in has been made (Y at S2460), it is recorded that the use state is a state of “CHECKED-IN” (X5).

If the check-in has not been made (N in S2460), the reservation managing module 313 determines whether the number of reservation counts is bigger than zero (S2470). The number of reservation counts means the number of reservations applied for the charging parking lot at this time. If the number of reservation counts is bigger than zero, it means that a reservation(s) has been applied for this charging parking lot. Alternatively, if the number of reservation counts is zero, it means that a reservation has not been applied for this charging parking lot and the charging space(s) is vacant so that the reservation managing module 313 records that the use state of this charging space is a state of “Usable (IDLE) (the use is enabled)” (X1). If the number of reservation counts is bigger than zero (that is, at the time of accepting the reservation), the reservation managing module 313 accepts a reservation for the charging space which is vacant at this time, and the number of reservation counts for the charging parking lot (or for the quick chargers) is reduced by one (S2480). For example, if the number of reservation counts is two, the number of reservation counts is reduced by one and it is recorded as one. In addition, the reservation managing module 313 records that the use state of the charging space is a state of “RESERVED” (X6).

The number of reservation counts is taken over in the succeeding determination on the use state of the charging space(s). Therefore, by repeating the above-mentioned determination process for the use state until the number of reservation counts becomes zero, the reservation managing module 313 is capable of receiving a reservation for the charging space while determining the use state of each charging space. In addition, by confirming the use states of all the charging spaces for each charging parking lot, it is possible to acquire the maximum use number of the charging spaces (or number of charging spaces of which use states are the state of “Usable (IDLE)” (X1)) for each charging parking lot. In a case of a charging parking lot provided with both the quick charger and the normal charger, the use state is preferably determined for each type of the charger 110.

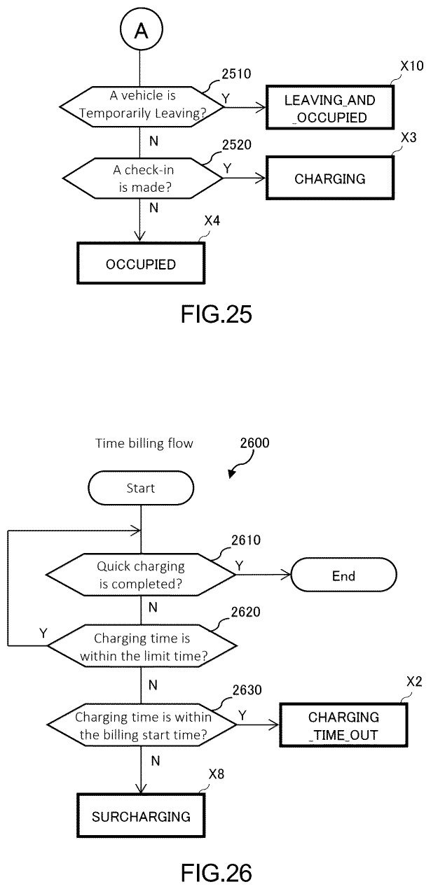

If there is no vehicle (N at S2420) at the time of determining of whether there is a vehicle in the charging space (S2420), the reservation managing module 313 determines whether a vehicle is temporarily leaving therefrom (S2510), as illustrated in FIG. 25. If it is temporarily leaving (Y at S2510), the reservation managing module 313 records that the use state is a state of “Temporary leaving preparation (LEAVING AND OCCUPIED)” (X10). Alternatively, if it is not temporarily leaving (N at S2510), then the reservation managing module 313 determines whether a check-in has been made (S2520). If a check-in has been made (Y at S2520), the use state is recorded as being a state of “OCCUPIED” (X4).

In a case of performing a charging operation with a quick charger (Y at S2410), the reservation managing module 313 performs a measurement of the charging time of the quick charger. Subsequently, the reservation managing module 313 determines whether the charging time of the quick charger is within a predetermined time range according to the time billing flow illustrated in FIG. 26 (S2620). If it is within the time range (or limit time) (Y at S2620), the charging time is monitored until the quick charging is completed (Y at S2610). It is recorded that the use state is a state of “OCCUPIED” (X4). If the charging time of the quick charger exceeds the predetermined limit time (N at S2620), then the reservation managing module 313 determines whether the charging time is within the billing start time at which the billing is started (S2630). If it is within the billing start time (Y at S2630), the reservation managing module 313 records that the use state is a state of “Exceeding the time limit (CHARGING TIME OUT)” (X7). If it is not within the billing start time (N at S2630), the reservation managing module 313 records that the use state is a state of “Billing (SURCHARGING)” (X4).

In a case where the reservation managing module 313 receives information indicating that some abnormality has occurred in the charging space, the use state is recorded as being a state of “Others (UNKNOWN)” (X11). According to the above-mentioned processes, the reservation managing module 313 is capable of perceiving the use states of the respective charging spaces by classifying them into eleven types of from X1 to X11. In a case where the reservation managing module 313 receives information indicating that the states of the respective charging spaces have been changed, for example, it sequentially records (or rewrites) the use states after the use states of the respective charging spaces are changed, according to the transition diagram illustrated in FIG. 23.

In FIG. 9, a charging possibility field 940, a restricting device field 950, and an informing device field 960 are illustrated. The charging possibility field 940 indicates an example of control of whether the charger is in the chargeable state when the charging space is in the state indicated in the state description field 920. The restricting device field 950 indicates an example of control of whether the restricting device 130 is in the restricting state when the charging space is in the state indicated in the state description field 920. The informing device field 960 indicates the light emission color and the light emission mode (in parentheses) of LED when the charging space is in the state indicated in the state description field 920. If the light emission mode is not described as (blinking), it means that the light is turned on. Incidentally, the control modes of the charger, the restricting device 130, and the informing device 140 are not limited thereto.

### Information Transmitting Process

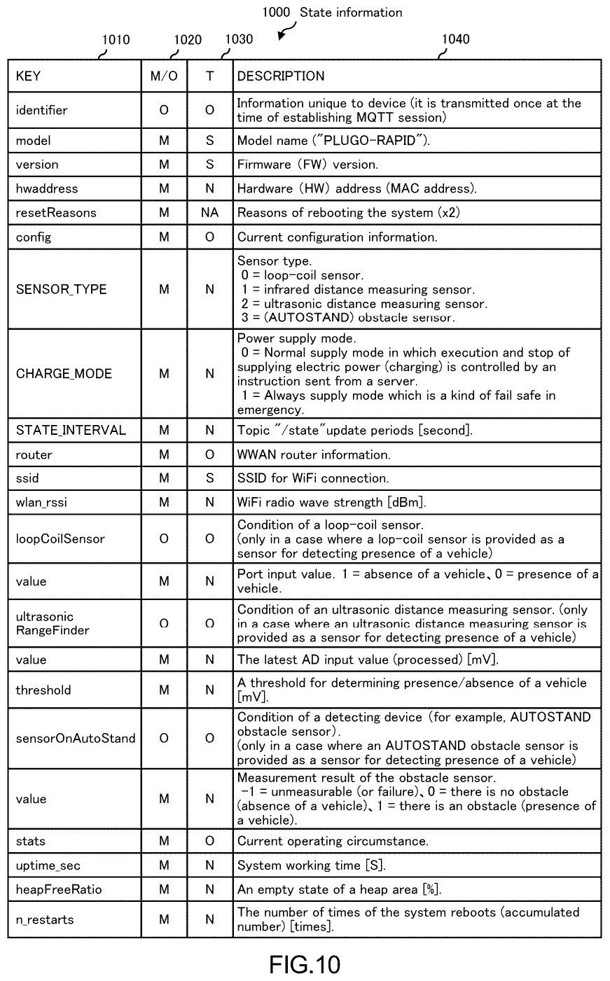

FIGS. 10 to 13 illustrate information to be transmitted and received between the managing server 102 and the charging space managing device 101.

FIG. 10 illustrates an example of state information 1000. The state information is information relating to the configuration and the like of the charging space managing device 101, and is transmitted from the charging space managing module 211 of the charging space managing device 101 to the managing server 102 at a predetermined time interval (for example, every 20 seconds). The state information includes information indicated in the key field (KEY) 1010, and information having the contents as indicated in the description field (DESCRIPTION) 1040 is inputted, as the forms indicated in the “M/O” field 1220 and the “T” field 1230. In this case, “M” in the “M/O” field 1220 indicates essential data (Must), and “O” indicates optional data (Optional). In addition, “T” in the “T” field indicates the data type (Type), and as the value of the field, “O” indicates the object type (Object), “S” indicates the character string type (String), “N” indicates the numerical type (Number), “NA” indicates the numerical array type (Number Array), and “B” indicates the logical type (Boolean), respectively.

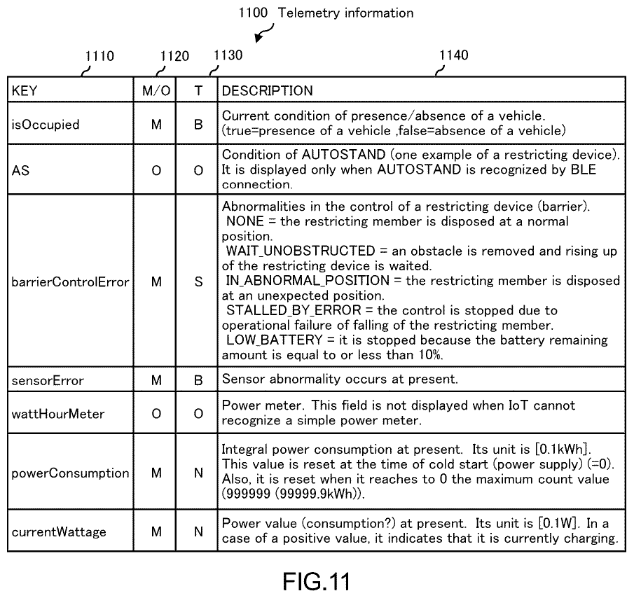

FIG. 11 illustrates an example of telemetry (telemetry) information 1100. The telemetry information 1100 is information relating to the state and the like of the charging space, and is transmitted (or updated) from the charging space managing module 211 of the charging space managing device 101 to the managing server 102 at the times when (1) the connection between the two is established and when (2) the content is changed. The state information includes information indicated in the key field (KEY) 1110, and information having the content as indicated in the description field (DESCRIPTION) 1140 is inputted, as the forms indicated in the “M/O” field 1220 and the “T” field 1230.

The telemetry information 1100 includes error information of the restricting device 130, the detecting device 120, and the like. For example, in any of the following cases, the managing server 102 notifies the user of the cancellation of the reservation when the charging space has been reserved, for example, and carries out a cancellation process, which will be described later.

In a case where an instruction is given to the restricting device 130 so as to put it into the restricting state, an abnormality is generated, and the correct restricting state is not achieved due to a contact between the restricting member 134 and some obstacle (for example, the rising operation of the restricting member 134 is not completed).

In a case where an instruction is given to the restricting device 130 so as to put it into the restricting state or the released state, the completion of the operation is confirmed, but an abnormality is generated, and the result is not in an expected state (for example, the restricting member 134 is not in the rising state).

In a case where an instruction is given to the restricting device 130 so as to put it into the restricting state or the released state, the managing server 102 does not receive the notification indicating the completion of the operation of the restricting device 130 within 10 seconds or within 30 seconds, respectively (for example, a malfunction of the communication control unit 207 is conceivable).

In a case where a person confirms that a malfunction of the operation of the detecting device 120, the restricting device 130, the informing device 140, or the like has occurred, the managing server 102 receives information indicating the malfunction

Incidentally, the conditions for performing the cancellation process are not limited to the above-mentioned examples.

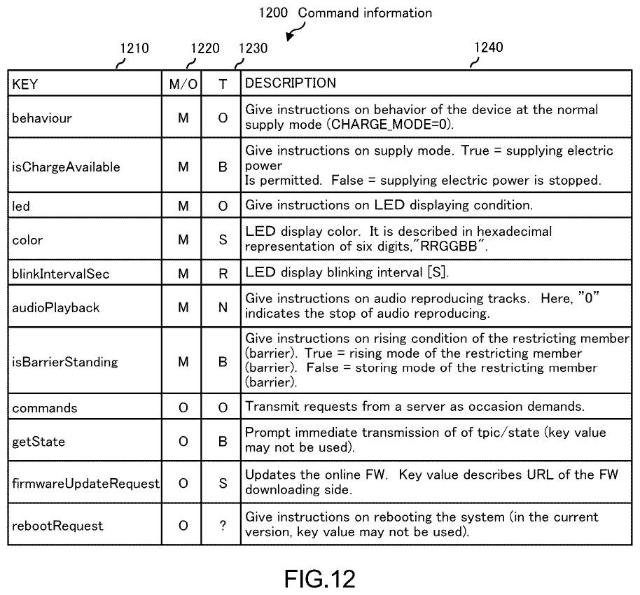

FIG. 12 illustrates an example of command information 1200. The command information 1200 is information transmitted from the managing server 102 to the charging space managing device 101 when it is required, and corresponds to information for instructing the operations of the respective devices provided in the charging space managing device 101 and the charging space. The command information includes information indicated in the key field (KEY) 1210, and information having the content as indicated in the description field (DESCRIPTION) 1240 is inputted, as the forms indicated in the “M/O” field 1220 and the “T” field 1230.

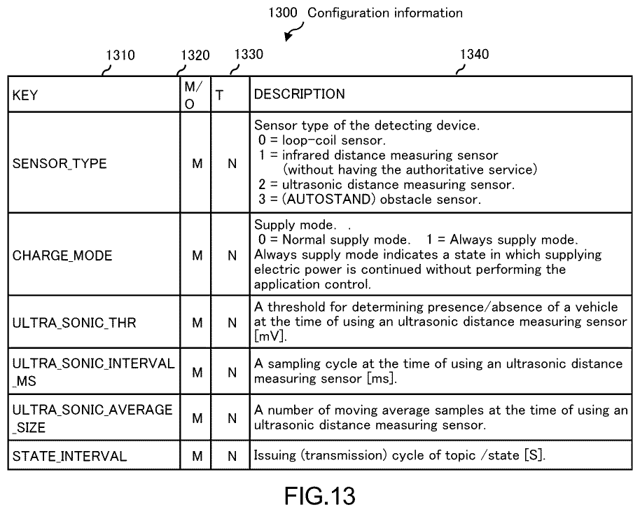

FIG. 13 illustrates an example of configuration information (or config information) 1300. The configuration information 1300 is setting information of the charging space managing device 101, and is made to be transmitted from the managing server 102 to the charging space managing device 101. The configuration information 1300 is recorded in the auxiliary storage device 302 of the managing server 102, and is configured to be actively acquired from the charging space managing device 101. In addition, the charging space managing device 101 records the acquired configuration information 1300 in the auxiliary storage device 202. When the configuration information 1300 is changed, the charging space managing device 101 updates the setting value, for example, by restarting it according to the need. The configuration information 1300 includes information indicated in the key field (KEY) 1310, and information having a content as indicated in the description field (DESCRIPTION) 1340 is inputted, as the forms indicated in the “M/O” field 1320 and the “T” field 1330.

### Entering Process (S1630)

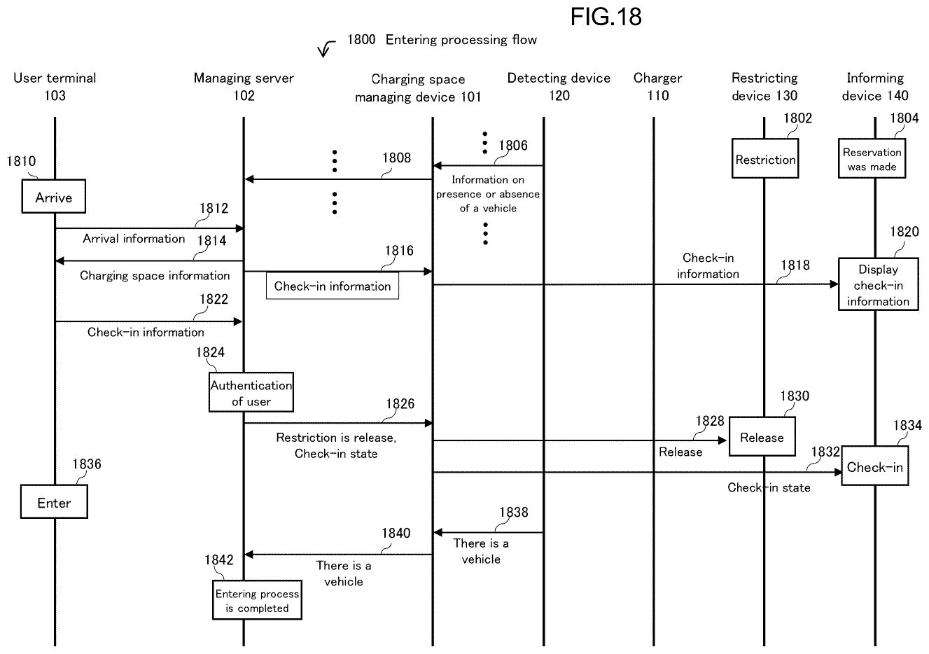

FIG. 18 illustrates an example of an entering processing flow (or parking processing flow) 1800.

A user who made a reservation for a charging space is supposed to move to the charging space in the charging parking lot to which the reservation has been made, by the user's vehicle until the end time of the short-time reservation. During the time period of the short-time reservation, the restricting device 130 maintains the condition of restricting the use of the charging space (S1802), and the informing device 140 indicates that a reservation has been made for the charging space (S1804). In addition, the detecting device 120 detects whether there is a vehicle in the charging space at a predetermined time interval, and the charging space state acquiring module 212 acquires the result (S1806). Further, the charging space managing device 101 transmits, to the managing server 102, information on presence or absence of a vehicle acquired by the charging space state acquiring module 212 (S1808).

When the user arrives at the charging parking lot for which the reservation has been made by a vehicle (S1810), the user selects the arrival notification button 3210 displayed on the reservation confirmation screen 3200 (see FIG. 32) to transmit the arrival information to the managing server 102 (S1812). When acquiring the arrival information from the user terminal 103, the user terminal managing module 311 of the managing server 102 displays information regarding the charging space in the reserved state on a display of the user terminal 103 (S1814). The user terminal managing module 311 displays, for example, a check-in screen 3300 as illustrated in FIG. 33, on the user terminal to display information on the charging space in the reserved state to the user. In the present example, for example, three charging spaces (indicated by the charging space numbers from 1 to 3) are in the reserved state (X5) and the user is informed that any one of the three charging spaces can be arbitrarily selected for using it.

The user moves to any one of the charging spaces for which the reservation has been made, based on information indicated in the check-in screen 3300, and executes check-in operation via the user terminal 103. For example, the check-in screen 3300 is configured so that numeric data (or number) of one of the three reserved charging spaces is made to be selected by using the select box 3310. The user selects the numeric data of the charging space for using it and selects the send button 3320. As a result, it becomes possible to transmit the check-in information on the charging space to be used, to the managing servers 102 (S1822). At this time, for example, when the check-in information including the user ID is transmitted, the user terminal managing module 311 is capable of performing authentication to determine whether the user is identical with the reserved user who made the reservation for the charging space (S1824). In this manner, it is constituted such that when there exists a plurality of charging spaces in the reserved state, the user is allowed to select an arbitrary charging space for using it. Therefore, for example, the user is allowed to select a charging space that is easy to park a vehicle for himself/herself and accordingly, it is possible to enhance the user's satisfaction.

The user terminal managing module 311 is capable of performing a confirmation that the user is identical with the reserved user by receiving an input from the user via the user terminal 103, and by confirming the matching of the check-in information received from the user with the check-in information transmitted to the charging space managing device 101 (S1824). As a result, the user is allowed to use the charging space, and the check-in operation is completed. The user terminal managing module 311 records that the use state of the charging space has been changed from the reserved state (X6) to the checked-in state (X5). Incidentally, the way of authenticating a user is not limited thereto, and, for example, an authentication (for example, authentication by QR coding (R)) between the user terminal 103 and the charging space managing device 101 may be used.

It is conceivable that there are various ways of authenticating a user. As another example, the user terminal managing module 311 transmits check-in information (for example, a numeric data of one of charging spaces to be used by the user) to the charging space managing device 101 (S1816), and then the charging space managing module 211 transmits, for example, the received check-in information to a display (which is one example of the informing device 140) of the charging space managing device 101 for displaying it (S1818, S1820). Subsequently, the user visually confirms the check-in information displayed on this display and inputs or selects the check-in information on the user terminal 103 to send it to the managing server 102 (S1822). The managing server 102 is also capable of carrying out the user authentication by confirming the matching of the check-in information transmitted to the charging space managing device 101 with the check-in information received from the user terminal 104. According to this method, the charging space to be used is designated for each user. Therefore, by some possibility, even if two or more reserved users arrive at a certain charging parking lot at the same time, it is possible to avoid an occurrence of overlapping in the charging space which is desired to be used.

When the user completes the check-in operation, the restricting module 314 outputs, to the charging space managing device 101, information for releasing the restriction on the use of the charging space (S1826). When the charging space managing device 101 receives the information for releasing the restriction on the use of the charging space, the charging space restricting module 213 transmits, to the restricting device 130, information for putting it into the state of releasing the restriction (S1828), and the restricting device 130 is put into the state (A) of releasing the restriction (S1830). In addition, the reservation managing module 313 outputs, to the charging space managing device 101, information indicating that the charging space is in the checked-in state (S1826). Then, the charging space managing module 211 transmits, to the informing device 140, information indicating that the charging space is in the checked-in state (S1832), and the informing device 140 displays that the charging space is in the checked-in state (S1834). Accordingly, the user is allowed to park a vehicle in the charging space.

When the user enters into the charging space to park a vehicle (S1836), the detecting device 120 detects that a vehicle is present in the charging space. Then, the charging space state acquiring module 212 acquires information indicating that a vehicle is present in the charging space, from the detecting device 120 (S1838), and the charging space managing module 211 transmits the acquired information to the managing server 102 (S1840). When the user terminal managing module 311 of the managing server 102 acquires the information indicating that the vehicle is present, it records that the use state of the charging space has been changed from the checked-in state (X5) to the chargeable state (X6). As a result, the entering process is completed (S1842).

### Charging Process (S1640)

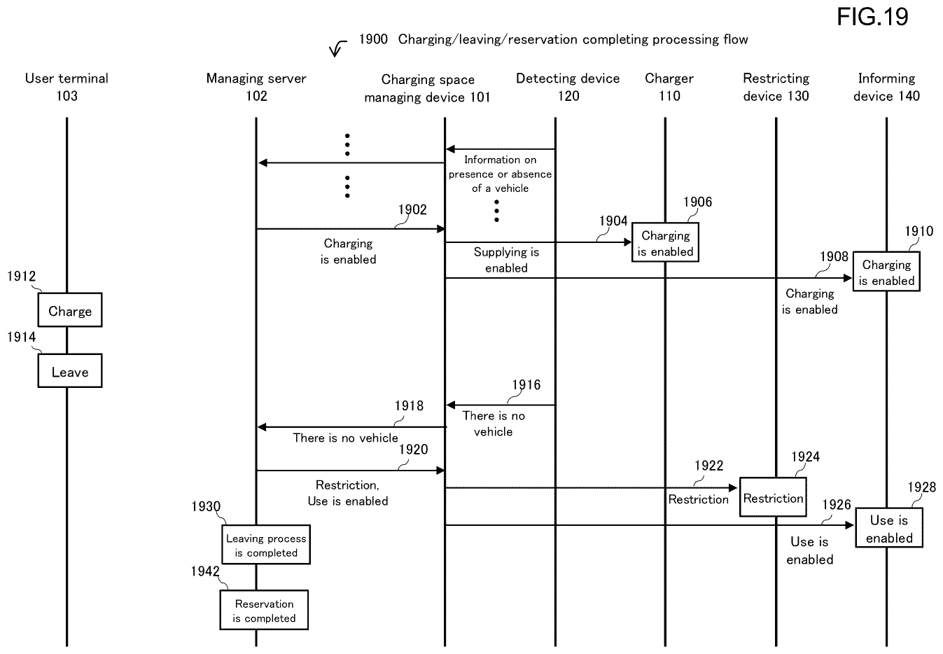

FIG. 19 illustrates an example of a charging/leaving/reservation completing processing flow 1900.

When the use state of the charging space becomes the chargeable state (X6), the restricting module 314 transmits, to the charging space managing device 101, information indicating that supplying electric power from the charger to the vehicle is enabled (S1902). The charging space restricting module 213 transmits, to the charger 110, the acquired information indicating that the charger is enabled to supply electric power (S1904), and then supplying electric power from the charger to the vehicle is enabled (S1906). For example, in a case where the charging connector of the charger 110 is provided with a locking mechanism, the charging space restricting module 213 releases the locking mechanism only when it is in the chargeable state (X6). In addition, for example, in a case where the charger 110 includes a suspend mode to suspend or stop supplying electric power, the charging space restricting module 213 releases the suspend mode when it is in the chargeable state (X6).

In addition, the user terminal managing module 311 transmits, to the charging space managing device 101, information indicating that the use state of the charging space becomes to be the chargeable state (X6) (S1902). The charging space restricting module 213 transmits, to the informing device 140, the acquired information indicating that the charger is enabled to supply electric power (S1908), and the informing device 140 displays that the charger is in the chargeable state (S1910). Accordingly, the user is informed that it is possible to supply electric power to the vehicle, and then, the user performs the charging operation according to the need (S1912).

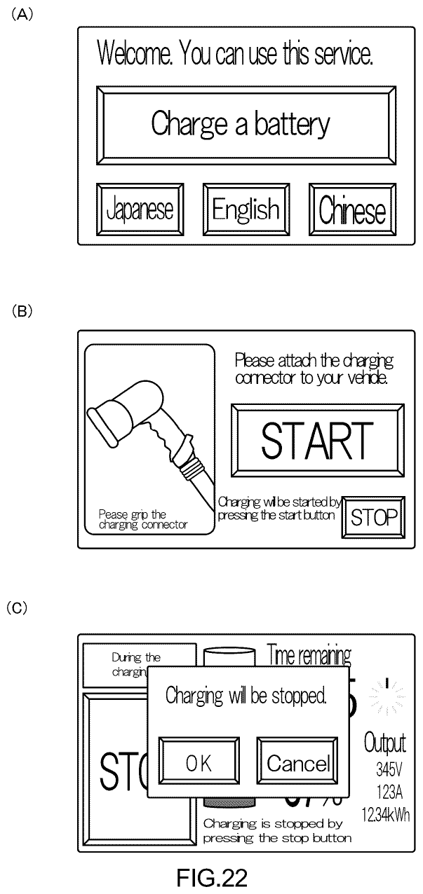

In FIGS. 22 (A) to (C), examples of screens of the touch panel type display of the charger 110 are illustrated.

At the time of performing the charging operation, for example, the user is allowed to directly operate the charging space managing device 101. For example, FIG. 22 (A) illustrates an initial screen of the charger 110. By selecting the charge button, it becomes possible to start the charging operation. FIG. 22 (B) illustrates an operation guidance screen of the charger 110. By following the operation guide, the charging connector is removed from the charger 110 and is attached to the charging port of a vehicle. Then, by pressing the start button on the guidance screen, the charging is made to be started. FIG. 22 (C) illustrates the guidance screen during the charging operation of the charger 110. In general, supplying electric power by the charger 110 is stopped automatically when it is fully charged or when a predetermined charging time elapses. If it is required to stop the charging operation at a midway, the charging operation may be stopped by pressing the stop button on the guidance screen before reaching the full charge or the predetermined charging time. After supplying electric power, the charging connector is detached from the charging port of the vehicle and is attached to the charging connector holder of the charger 110.

### Leaving Process (S1650)

When using of the charging space is finished, the user takes out the vehicle from the parking space to leave the space (S1914). Then, the detecting device 120 detects absence of a vehicle in the charging space. The charging space state acquiring module 212 acquires information indicating that there is no vehicle, from the detecting device 120 (S1916), and transmits the information to the state acquiring module 312 (S1918). When acquiring the information indicating absence of a vehicle, the user terminal managing module 311 records that the use state of the charging space has been changed from the chargeable state (X6) to the reservation available state (X1). Accordingly, the user terminal managing module 311 makes the maximum number of reservations of the quick chargers provided in the charging parking lot increase by one.

In addition, the restricting module 314 transmits, to the charging space managing device 101, information for causing the restricting device 130 to be put into the restricting state (S1920). When receiving the information for putting the restricting device 130 into the restricting state, the charging space restricting module 213 transmits, to the restricting device 130, the information for causing it to be put into the restricting state (S1922), and them the restricting device 130 is put into the restricting state (B) (S1924). Also, the restricting module 314 transmits, to the charging space managing device 101, information indicating that supplying electric power from the charger to a vehicle is enabled (S1920). The charging space restricting module 213 transmits, to the charger 110, acquired information indicating that supplying electric power by the charger is not enabled, and supplying electric power from the charger to a vehicle is restricted.

In addition, the user terminal managing module 311 transmits, to the charging space managing device 101, information indicating that the charging space is in the usable state, with regard to the informing device 140 (S1920). The charging space managing module 211 transmits the received information to the informing device 140 (S1926), and the informing device 140 displays that it is in the usable state (S1928).

### Reservation Completing Process (S1660)

FIG. 36 illustrates an example of a use completion screen 3600.

When the leaving process is completed, the user terminal managing module 311 starts the payment process for the use fee of the charging space. For example, at the time of performing the normal charging, the constant-current charging is generally adopted so that it is possible to perform the payment based on the use time of the charger when it is in the chargeable state (X6). In a case of performing the quick charging, in general, the constant-current constant-voltage charging is performed, and the constant-voltage charging is started after the charging rate becomes high, so that it is possible to perform the payment of the use time of the charger when it is in the chargeable state (X6) similarly to the case of the normal charging. When the payment process is completed, the user terminal managing module 311 records that the reservation of the charging space is completed.

### Cancel Process

There may be a case in which the reservation for the charging space is cancelled, for example, if the user changes the schedule. In addition, there may be a case in which the user may not reach the reserved charging parking lot within the time period of the short-time reservation if it takes a long time for the user to move thereto. The user terminal managing module 311 determines that the reservation for the charging space is cancelled if it does not accept at least one of the arrival information and the check-in information within the time period of the short-time reservation. In addition, there may be a case where the charging space in the reserved state may not be used, for example, due to a malfunction of the restricting device 130 or the detecting device 120 (see FIG. 11). When the cancellation of the reservation is accepted or the reservation is canceled, for the charging space in the reserved state in this way, the user terminal managing module 311 records that the use state of the charging space has been changed from the reserved state (X6) to the reservation available state (X1), from the user terminal 103. Then, the processes after S1920 at the time of the leaving process are executed. And then, the cancellation of the reservation is recorded.

### Temporary Leaving Process

After the use of the charging space, for example, as described above, the payment is made at the time of leaving from the charging space, according to the need. However, for example, as illustrated in FIG. 34, the reservation managing system 100 may be configured to perform the “temporary leaving” process, from the chargeable state (X3), to enable the temporary leaving without making the payment. In this case, it is possible to maintain the reserved state of the charging space even after the exit from the space.

A vehicle in the chargeable state (X3) may temporarily leave the space without making the payment. At the time of the temporarily leaving, the user selects, for example, the temporarily leaving button 3410 displayed on the charging state display screen 3400. This leads to the transmission of information indicating that the charging space is not temporarily used, from the user terminal 103 to the managing server 102. When the managing server 102 receives the information indicating that the charging space is not temporarily used, the user terminal managing module 311 records that the use state of the charging space has been changed from the chargeable state (X3) to the temporary leaving preparation state (X10). Supplying electric power from the charger to a vehicle is restricted by the restricting module 314. At this time, the detecting device 120 detects presence of a vehicle in the charging space. In addition, the user terminal managing module 311 may display, for example, the temporarily leaving state display screen 3500 as illustrated in FIG. 35, on the user terminal 103.

When the vehicle temporarily leaves the parking space and the detecting device 120 detects absence of a vehicle in the charging space, the detecting device 120 transmits information indicating absence of a vehicle to the charging space managing device 101. The charging space managing module 211 transmits information indicating absence of a vehicle to the managing server 102. When the user terminal managing module 311 receives the information indicating absence of a vehicle, it records that the use state of the charging space has been changed from the temporary leaving preparation state (X10) to the temporary leaving state (X9). In addition, the user terminal managing module 311 transmits, to the charging space managing device 101, information indicating that the use state of the charging space becomes to be the temporary leaving state (X9). When the charging space managing device 101 receives the information indicating that the use state of the charging space becomes to be the temporary leaving state (X9), the charging space restricting module 213 transmits, to the restricting device 130, information for restricting the entry of a vehicle, and the restricting device 130 is put into the restricting state (B). In addition, the charging space managing module 211 transmits, to the informing device 140, information indicating that the charging space is in the temporarily leaving state, and the informing device 140 displays information indicating the temporarily leaving state. Accordingly, even in a state where there is no vehicle in the charging space, it is possible to restrict the entry of another vehicle so that the reserved state is able to be maintained.

When putting the vehicle back into the charging space again, for example, the user selects the re-entry button 3510 displayed on the temporarily leaving state display screen 3500. This leads to the transmission of information indicating of re-entering into the charging space, from the user terminal 103 to the managing server 102. When the managing server 102 acquires the information indicating of the re-entering, the user terminal managing module 311 records that the use state of the charging space has been changed from the temporarily leaving state (X9) to the checked-in state (X5). After that, it becomes possible to carry out the entering process in accordance with the above-mentioned steps of from S1826 to S1842.

### Time Billing

The quick charger is configured to convert electric power into high voltage direct current at the side of the charger for sending it to a vehicle so that the quick charger is capable of performing full charge in a short time, but the charging time is limited for protecting the battery and the equipment. Accordingly, in the reservation managing system 100, the charging by the quick charging (or by the quick charger) may be configured to be finished when reaching a predetermined time (for example, 60 minutes from the start of the charging). In addition, after the charging by the quick charging, if a predetermined leaving time (for example, 75 minutes from the start of the charging) is exceeded, excess charge (or extra fee) may be generated for the extra time.

In such a case, as described above, the user terminal managing module 311 determines the use state of the charging space according to the billing flow illustrated in FIG. 26, and when a change occurs in the use state, the user terminal managing module 311 records the use state after the change. That is, if the charging time exceeds a predetermined limit time, it records that the use state has been changed from the chargeable state (X3) to the occupied state (X4), and, for example, transmits information indicating that the use state is the occupied state (X4) to the charging space managing device 101, and the informing device 140 is caused to display that the use state of the charging space is the occupied state (X4). In addition, if the charging time exceeds a predetermined billing start time, it records that the use state has been changed from the occupied state (X4) to the limit time exceeding state (X7), and, for example, transmits information indicating of the limit time exceeding state (X7) to the charging space managing device 101, and the informing device 140 is caused to display that the use state of the charging space is the limit time exceeding state (X7).

### Use of the Charging Space Without Having a Reservation, 1

The charging space may be used without having a reservation in addition to the above-mentioned use after making a reservation. In this case, for example, a user without having a reservation applies for the use of the charging parking lot by using a software (or application) provided by the reservation managing system 100, at the charging parking lot. For example, a user without having a reservation selects a type of charger by pressing the charging type selection button 2910 on the reservation screen 2900 of the charging parking lot as illustrated in FIG. 29, and applies for the use by selecting the charging start button 2930. When receiving the application for use from the user without having a reservation (or non-reserved user), for example, the user terminal managing module 311 decides a charging space which is available according to the state managing flow 2400 as illustrated in FIG. 24, and notifies (or displays) it to the user terminal 103 of the non-reserved user. The non-reserved user executes a check-in operation for the notified charging space. As a result, the user terminal managing module 311 determines that the use state of the charging space with regard to the non-reserved user is the checked-in state similarly to the case of the reserved user (or user having a reservation) (see FIG. 23). Thereafter, the non-reserved user is allowed to use the charging space similarly to the case of the reserved user.

### Use of the Charging Space Without Having a Reservation, 2

Although the managing server 102 monitors the use states of the respective charging spaces at a predetermined cycle and timing, there is a possibility that a non-reserved user may enter into a charging space. For example, there may be a case that a non-reserved user moves a vehicle into a charging space at substantially the same time when a reserved user leaves the charging space after using the charging space. In such a case, as indicated by a dotted line in the state transition diagram 2300 in FIG. 23, the user terminal managing module 311 determines that the use state of the charging space used by the non-reserved user is the occupied state. The non-reserved user may change the use stat to the chargeable state by executing the check-in operation while parking a vehicle in the charging space. For this reason, for example, the user terminal managing module 311 outputs information for causing the informing device 140 to display the check-in request, with respect to the charging space managing device 101 of the charging space which becomes to be the occupied state. Then, the charging space managing module 211 outputs information for causing the informing device 140 to prompt to carry out the check-in operation, and then the informing device 140 displays information for prompting to carry out the check-in operation. When the user carries out the check-in operation, the user terminal managing module 311 determines that the use state of the charging space, by the non-reserved user, has been changed from the occupied state (X4) to the chargeable state (X3) (see FIG. 23). Thereafter., the non-reserved user is allowed to use the charging space similarly to the case of the reserved user.

### Operational Effects

The reservation managing system 100 according to the present technology is configured to determine whether the use state of the charging space(s) is the reservation available state, based on information on presence or absence of a vehicle in the charging space, and to accept a reservation when the use state is the reservation available state. In addition, in a case where a reservation is accepted, the restricting device provided in the charging space is put into a state of restricting the use of the above-mentioned charging space. According to such a configuration, for example, it is possible to accept a reservation for only a charging space without making a reservation for an electric vehicle. In addition, it is possible to accept a reservation for the charging space while providing the charging space to a vehicle without having a reservation. As a result, for example, a user is capable of making a reservation for the charging space even when using the charging space with an electric vehicle owned by the user. Since the possibility of making a reservation for the charging space is determined based on information on presence or absence of a vehicle in the charging space at the time of the reservation, it is possible to accept a reservation that is not a daily basis of the day, for example, a reservation that is on the premise of the use in a shorter time than the business hours such as in a range of from one hour to several hours. As a result, it is possible to accept a plurality of reservations per day for one charging space, and thus it becomes possible to increase the operating rate of the charging parking lot.

In such a configuration, the time period of the short-time reservation is set to secure a reservation for the charging space for a predetermined time period starting from the reservation time. In addition, a reservation is made to be cancelled if its use is not started within a predetermined time period of the short-time reservation. Accordingly, it is possible not to excessively impair a use opportunity for a user without having a reservation. Furthermore, it is possible to accept more reservations per day for one charging space.

In such a configuration, a fee is not charged for making a short-time reservation for a charging space. Accordingly, it is possible to provide reservation service for a charging space at an affordable price, and accordingly, it is expected that the reservation service is used by more users. Alternatively, for example, a fee may be charged for making a short-time reservation for a charging space. In this case, it is possible to provide a user who desires to use the charging space even with the payment for making a short-time reservation with more opportunity to make a reservation for the charging space.

In such a configuration, the managing server determines the use state of the charging space, and, for example, causes the informing device 140 to notify that making a reservation for the charging space is enabled and that a reservation for the charging space is made. For example, this may reduce the likelihood that a user may accidentally enter into a different charging space due to misunderstanding that the space is the reserved or non-reserved charging space available to the user. In addition, the managing server determines the use state of the charging space in detail, and causes the informing device 140 to notify the respective use states. Accordingly, the user is allowed to perceive the use state of the charging space, and is capable of safely and securely using the charging space.

In such a configuration, the user terminal managing module 311 is capable of identifying a state in which a non-reserved user enters into a charging space before carrying out the check-in operation, as an occupied state. With such a configuration, it is possible to safely provide a charging space even for a vehicle without having a reservation, while accepting a reservation for the charging space.

In such a configuration, when receiving check-in information and when confirming that the charging space is in the reserved state, the restricting device is put into a state of releasing the restriction of use of the charging space. Accordingly, it is possible to permit the use of the charging space only when the reserved user uses the reserved charging space.

In such a configuration, when the reservation managing module 313 receives temporarily leaving information indicating that a vehicle temporarily leaves, and when the state acquiring module 312 receives information indicating absence of a vehicle in the charging space, the restricting module 314 puts the restricting device into the restricting state. Accordingly, the charging space is put into the restricting state immediately after a vehicle temporarily leaves, and accordingly, it is possible to prevent the entrance of another vehicle. Therefore, at the time of using the charging space for a long time, for example, for staying overnight, it is possible to temporarily leave the charging space safely while maintaining the reserved state of the charging space.

### Second Embodiment

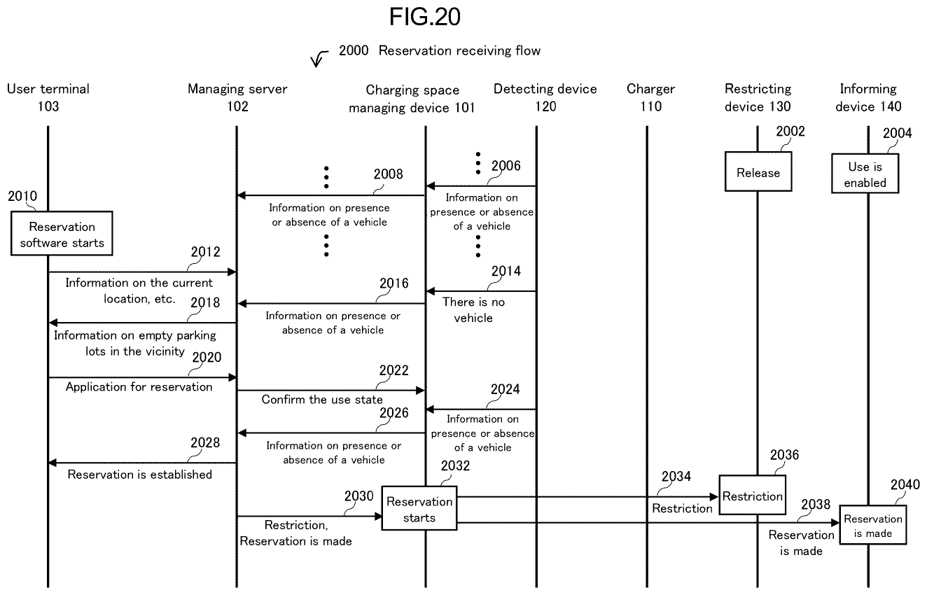

FIG. 20 illustrates another example of a reservation receiving flow 2000.

According to the first embodiment, the restricting device 130 is put into the restricting state to prevent the entrance of a vehicle into the charging space when it is in the usable state. However, as illustrated in FIG. 20, according to the reservation managing system 100 of the second embodiment, the restricting device 130 is put into a state in which entering of a vehicle into the charging space is not restricted when it is in the usable state (see S2002, S2004). Other configurations and operational effects may be the same as those of the first embodiment, and the overlapping descriptions thereof will be omitted.

In such a case, the processes may be executed similar to the case of the first embodiment until receiving an application for reservation (S2020) from the activation of the reservation software (S2010). At the time of receiving an application for reservation from the user terminal 103, the user terminal managing module 311 confirms the use states of all the charging spaces in the charging parking lot for which the application for reservation is made, according to the state managing flow 2400 (S2022). The charging space state acquiring module 212 of the charging space managing device 101 connects to the detecting device 120 to acquire information on presence or absence of a vehicle (S2024), and transmits the information to the managing server 102 (S2026).

At this time, if there is a charging space for which making a reservation is enabled in the charging parking lot, a reservation is established. Therefore, the managing server 102 executes the reservation processes generally similarly to the case of the first embodiment. That is, the reservation managing module 313 transmits information indicating that a reservation is established, to the user terminal 103 (S2028). In addition, the restricting module 314 outputs, to the charging space managing device 101 corresponding to the charging space of the charging parking lot for which a reservation is made, information causing the restricting device 130 to be put into the restricting state (B) for restricting the use of the charging space (S2034), and the reservation managing module 313 transmits information indicating that a reservation for the charging space is made (X6) to be informed by the informing device 140 (S2030). Then, the charging space restricting module 213 of the charging space managing device 101 outputs, to the restricting device 130, information for causing it to be put into the restricting state for restricting the use of the charging space (S2034), and the restricting device 130 is put into the restricting state (S2036). Further, the charging space managing module 211 outputs, to the informing device 140, information indicating that a reservation for the charging space is made (S2038), and the informing device 140 outputs information indicating that the charging space is reserved (S2040).

On the other hand, if there is no charging space for which making a reservation is enabled, it is conceivable that there is a case where a vehicle enters into the charging space without having a reservation, and a case where the detecting device 120 detects that a person or a vehicle temporarily enters into the charging space. Then, the reservation managing module 313 waits for a predetermined waiting time (typically, in a range of from 10 to 30 seconds, for example, about 10 seconds), and then confirms the use state again according to the state managing flow 2400 (not shown). At this time, a reservation is established by the managing server 102 if there is a charging space for which making a reservation is enabled, and the reservation process is made to be completed according to the steps of from S2028 to S2040. However, if there is no charging space for which making a reservation is enabled, one more time, it may be determined that a vehicle enters into the charging space without having a reservation. Therefore, the reservation managing module 313 transmits information indicating that the reservation is not established to the user terminal 103, and displays the reservation screen 2700 or 2800 again for accepting an application for reservation for another charging parking lot from the user.

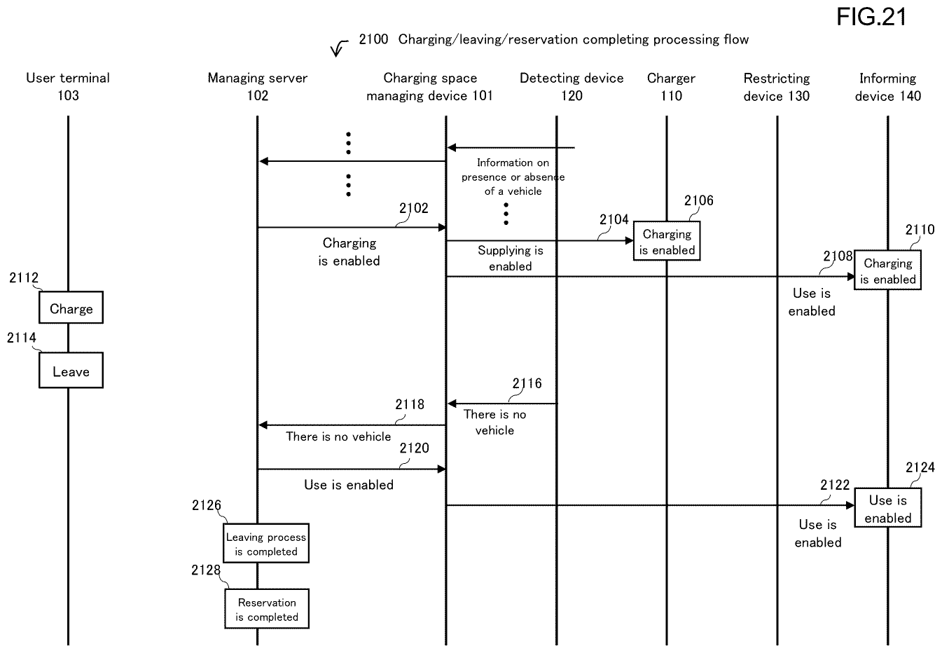

FIG. 21 illustrates another example of a charging/leaving/reservation completing processing flow 2100.

The flow during a period from after the completion of the reservation to the detection of absence of a vehicle by the detecting device 120 after the leaving (S2118) may be executed similar to the case of the first embodiment.

When the state acquiring module 312 of the managing server 102 acquires information indicating that there is no vehicle in the charging space (S2118), the user terminal managing module 311 records that the use state of the charging space has been changed from the chargeable state (X6) to the reservation available state (X1). Accordingly, the user terminal managing module 311 makes the maximum number of reservations for the quick chargers in the charging parking lot increase by one.

In addition, the restricting module 314 transmits, to the charging space managing device 101, information indicating that supplying electric power from the charger to a vehicle is enabled (S1920). In this case, the restricting module 314 does not transmit information for putting the restricting device into the restricting state. The charging space restricting module 213 transmits, to the charger 110, acquired information indicating that supplying electric power by the charger is not enabled, and supplying electric power from the charger to a vehicle is restricted.

The user terminal managing module 311 transmits, to the charging space managing device 101, information indicating that the charging space is in the usable state, with respect to the informing device 140 (S1920). The charging space managing module 211 transmits the received information to the informing device 140 (S1926), and the informing device 140 displays that it is in the usable state (S1928).

In such a configuration, the restricting device 130 does not record (or restrict) the entry of a vehicle when the charging space is in the usable state so that it is possible to motivate a user having an electric vehicle to use the charging space without having a reservation. Accordingly, the use opportunity of the charging parking lot may be enhanced. In addition, whether the restricting device 130 is put into the restricting state or the restriction releasing state when it is in the usable state may be easily selected by the program that is activated by the managing server 102. Therefore, the state of the restricting device 130 during the usable state may be determined according to, for example, the number of users using each charging parking lot, the attributes, and the like.

The present invention is not limited to the above-described embodiments, and includes various modifications. For example, the above-described embodiments have been explained in detail for the purpose of clearly illustrating the present invention, and are not necessarily limited to those having all the described configurations. Further, it is possible to replace a part of the configuration of one embodiment with the configuration of another embodiment, and it is also possible to add the configuration of one embodiment to the configuration of another embodiment. Further, it is possible to add, delete, or replace a part of the configuration of each embodiment with other configuration.

In the above-mentioned embodiments, it is confirmed that the user is identical with the reserved user by acquiring the check-in information that is transmitted to the user terminal 103 or the charging space managing device by the managing server, from the charging space managing device or the user terminal. However, the way of authenticating the user is not limited thereto. For example, when the reservation managing module 313 confirms that the reservation identification information relating to the reservation is identical with the identification information relating to the check-in information, the restricting module 314 may put the restricting device 130 into the state for releasing the restriction of use of the charging space. Specifically, for example, when it is confirmed that the reservation ID notified to the user terminal 103 at the time of making a reservation is identical with the reservation ID transmitted from the user terminal 103 at the time of carrying out the check-in operation, the restricting module 314 may put the restricting device 130 into the state for releasing the restriction of use of the charging space.

In addition, for example, in a case where the detecting device 120 is a vehicle number reading device, the restricting module 314 may put the restricting device 130 into the state for releasing the restriction of use of the charging space when it is confirmed that the vehicle number of the reserved vehicle that is registered at the time of making a reservation is identical with the vehicle number that is read by the vehicle number reading device at the time of carrying out the check-in operation. Also, the charging process may be permitted by the reservation managing module 313. Accordingly, it is possible to perform the check-in operation while alleviating the user's burden.

It is possible to appropriately modify the use state managing flow illustrated in FIGS. 24 to 26 in the above-described embodiments according to the equipment of the charging parking lot and the charging system to be applied. For example, at the time of perceiving the use state of the charging space(s) in the charging parking lot provided with only one type of the normal charger and the quick charger as the charger, the confirmation of the type of charging does not need to be performed, and therefore, for example, it is possible to omit the step S2420. In addition, it is possible to determine whether the billing flow is executed with respect to the use of all the charging spaces.

In addition, for example, in a case of perceiving the use state of the charging space(s) in the charging parking lot provided with both of the normal charger and the quick charger, the billing flow which differs depending on the type of the charger may be executed after having confirmed the type of the charger at S2420. At this time, in any case, the setting of the time at which the billing process is started and the time at which excess charge is generated may be arbitrarily adjusted.

In the state-transition diagram illustrated in FIG. 23 according to the above-mentioned embodiment, a route for transitioning from the temporarily leaving state (LEAVING; X9) to the temporarily leaving preparation state (LEAVING_AND_OCCUPIED; X10) is not indicated. However, the charging space does not necessarily have to be provided with the charging space restricting device 130 for restricting the entry of a vehicle, and in such a case, it may be configured to be capable of being transited from the temporarily leaving state (X9) to the temporarily leaving preparation state (X10). In this case, the informing device 140 may display to notify the use state of the charging space. Alternatively, it may be configured to detect a state in which a special vehicle such as a vehicle having a high height is parked exceeding the restricting device 130 even though the restricting device 130 is in the restricting state.

In the above-mentioned embodiments, each charging space is provided with a charger. However, the reservation managing system 100 according to the present technology is not limited to the application to the reservation system of the charging parking lot provided with a charger(s). For example, the present invention may be applied to a charging parking lot in which no charger is provided in one or two or more charging spaces, or to a reservation system of a parking lot in which no charger is provided.

In the above-mentioned embodiments, one charging space is provided with one charger 110. However, the charger does not necessarily have to be provided in each one of charging spaces. For example, one charger 110 may be provided between two adjacent charging spaces. In such a case, the managing server 102 may be configured to accept a reservation also for the charging time when accepting a reservation. The managing server 102 may be configured to accept a reservation if there is a charging space in which making a reservation is enabled (or its use is enabled), on the conditions that there is no vehicle in the charging space and that the charging time is not overlapped with another one. Then, when the conditions that the check-in operation is made and that there is a vehicle in the charging space are satisfied, the usable state may be changed to “charging waiting state” not to “chargeable state”, and then, when the condition that it is within the period of the charging reservation time is satisfied, the use state may be changed to “chargeable state”.

In the above-mentioned embodiments, the restriction member which is configured to be rotated for restricting the entry of a vehicle into the charging space is exemplified as the restricting device. However, the restriction member is not limited to this example. For example, the shape of the restriction member is not limited to the plate-shaped member, and it may be configured to have a different shape such as a rod shape, a mesh shape, a fence shape, and a sheet shape. Also, the operation of switching between the restricting state and the restriction releasing state is not particularly limited. For example, in addition to the configuration of being displaced by rotation with respect to the axis elongating along the horizontal direction, the restriction member may be configured to be displaced by rotation with respect to the axis elongating along the vertical direction, by another rotation, by ascending, by descending, or by movement in the horizontal direction, for switching between the restricting state and the restriction releasing state.

The data processing executed by the detecting device 120 has not been described in the above-mentioned embodiments. However, for example, at least one of the charging space managing device 101 and the managing server 102 (for example, the charging space managing device 101) may be configured to adopt information on presence or absence of a vehicle, acquired by the detecting device 120, by organizing the information as described below.

For example, the measurement value detected by the detecting device may be converted into a binary value indicating whether a vehicle is present or not, for example, based on a predetermined threshold value, with respect to the measurement value acquired in a predetermined detection period.

In a case where the detecting device is, for example, an ultrasonic distance measuring sensor, a sampling period (for example, 300 milliseconds) may be inputted by AI (or artificial intelligence), a moving average may be calculated for a predetermined sampling number (for example, 30 samples), and presence or absence of a vehicle may be determined depending on whether the moving average value is equal to or less than a predetermined threshold value (for example, in a range of from 600 to 650 mV) (in this case, a vehicle is present) or less than the threshold value (in this case, no vehicle is present).

In a case where the detecting device is an ultrasonic sensor, a measurement value at the time of sampling may be adopted as the measurement value.

In addition, for example, a value after a predetermined buffer time (for example, 10 seconds) after the start of the acquisition may be adopted as the defined value.

In addition, in a case where the detecting device is, for example, a loop-coil type sensor, data (for example, HI) indicating presence of a vehicle or data (for example, LO) indicating of absence of a vehicle may be acquired sequentially for each circulation.

When the restricting device is provided with a restriction member to prevent the entrance of a vehicle by rotating from a horizontal posture to a vertical posture, and when a detecting device is provided for detecting presence or absence of an obstacle in the vicinity (for example, at a peripheral edge of the restricting device or at an outer side in the rotational radial direction) in a case where the restriction member is in the horizontal posture, a sampling value may be adapted at a predetermined period (for example, in a range of from 10 to 30 seconds).

The value indicating presence or absence of a vehicle thus acquired, for example, may be stored and managed at the side of the managing server 10.

The present technology provides a method for managing a reservation, including the steps of:
acquiring information on presence or absence of a vehicle in a charging space;
determining whether a use state of the charging space is a reservation available state based on the acquired information, and accepting a reservation for the charging space in a case where the charging space is in a reservation available state; and
putting a restricting device provided in the charging space into a state for restricting use of the charging space, in a case where the reservation has been accepted.

This method is included in the above-mentioned embodiments.

The present technology also provides a program for causing a server to execute the respective steps (or processes) included in the method for managing a reservation. This program may be composed of one program or it may be composed of two or more subprograms. Further, it may be configured as a program for causing a server to execute any one or two or more of the above-mentioned steps.

The present technology provides a method for managing a charging space, including the steps of:
acquiring information on presence or absence of a vehicle in a charging space by using a detecting device provided in the charging space;
transmitting the information on presence or absence of a vehicle, acquired by the charging space state acquiring unit, to a reservation managing device for managing a reservation of the charging space, and acquiring information on restricting use of the charging space from the reservation managing device, and
putting a restricting device provided in the charging space into a state for restricting the use of the charging space in a case where the charging space managing device acquires information on restricting the use of the charging space.

This method is included in the above-mentioned embodiments.

The present technology also provides a program for causing a computer to execute the respective steps (or processes) included in the method for managing a charging space. This program may be composed of one program or it may be composed of two or more subprograms. Further, it may be configured as a program for causing a computer to execute any one or two or more of the above-mentioned steps.

In addition, some or all of the above-described configurations, functions, processing units, processing means, and the like may be realized by hardware, for example, by designing them with an integrated circuit. The above-described configurations, functions, and the like may be realized by software with which a processor is caused to interpret and execute the program for realizing the respective functions. Information such as programs, tables, and files for realizing the respective functions may be stored in a storage device such as a memory, a hard disk, or an SSD (or Solid State Drive). or a storage medium such as an IC card, an SD card, or a DVD.

In addition, control lines and information lines which are considered to be necessary for explanation are illustrated, and not all control lines and the information lines are necessarily illustrated for explaining the product. In practice, almost all of the configurations may be considered to be interconnected with each other.

The present technology is not limited to the provision of the respective elements of the reservation managing device and the method for managing a reservation, and may be understood as providing the reservation managing system 100 including these elements.

In addition, any one or two or more of elements of one or a plurality of the charging space managing device 101, one or a plurality of the managing servers 102, and one or a plurality of the user terminals 103, constituting the reservation managing system 100, may be provided in different countries. In addition, the managing server 102 may be configured by one or a plurality of computers, and any one of them may be provided in different countries.

The above-mentioned embodiments disclose at least the following configurations.
(1) A reservation managing device, includes:
   a state acquiring unit for acquiring information on presence or absence of a vehicle in a charging space;
   a reservation managing unit for determining whether a use state of the charging space is a reservation available state based on the information acquired by the state acquiring unit, and for accepting a reservation for the charging space in a case where the charging space is in a reservation available state; and
   a restricting unit for putting a restricting device provided in the charging space into a state for restricting use of the charging space, in a case where the reservation has been accepted by the reservation managing unit.
(2) The reservation managing device as recited in (1), wherein the charging space is provided with an informing device for outputting a use state of the charging space.

The reservation managing unit is configured to output, to the informing device,
information indicating that the charging space is available for reservation, when having determined that the charging space is in a reservation available state, and
information indicating that the charging space is reserved, when having accepted the reservation.
(3) The reservation managing device as recited in (2), when the charging space is in a reservation available state, and the state acquiring unit has acquired information indicating that a vehicle is present in the charging space, the reservation managing unit outputs, to the informing device, information indicating that the charging space is in an occupied state.
(4) The reservation managing device as recited in (3), wherein the reservation managing unit is configured to accept check-in information indicating that use of a charger provided in the charging space has been allowed, and in a case where the charging space is in an occupied state, and the reservation managing unit has accepted the check-in information, the restricting unit enables charging (or supplying electric power) by a charger to a vehicle.
(5) The reservation managing device as recited in any one of from (1) to (4), wherein the reservation managing unit is configured to accept check-in information indicating that use of a charger provided in the charging space has been allowed, and in a case where the charging space is in a reservation available state, and the reservation managing unit has accepted the check-in information, the restricting unit puts the restricting device into a state for releasing restriction of use of the charging space.
(6) The reservation managing device as recited in (5), wherein the reservation managing unit is configured to accept check-in information indicating that use of a charger provided in the charging space has been allowed, and in a case where the charging space is in a reservation available state, and the reservation managing unit has accepted information indicating that a vehicle is present in the charging space, after accepting the check-in information, the restricting unit enables charging by a charger to a vehicle.
(7) The reservation managing device as recited in any one of from (1) to (6), wherein the reservation managing unit is configured to accept check-in information indicating that use of a charger provided in the charging space has been allowed, and in a case where the reservation managing unit has accepted the check-in information and confirmed that the charging space is in a reserved state, the restricting unit puts the restricting device into a state for releasing restriction of use of the charging space.
(8) The reservation managing device as recited in (7), when the reservation managing unit has confirmed that reservation identification information relating to the reservation and identification information relating to the check-in information are identical, the restricting unit puts the restricting device into a state for releasing restriction of use of the charging space.
(9) The reservation managing device as recited in (7), wherein the reservation managing unit is configured to accept check-in information indicating that use of a charger provided in the charging space has been allowed, and in a case where the charging space is in a reserved state, and the reservation managing unit has accepted the check-in information, the reservation managing unit outputs, to the informing device provided in the charging space, information indicating that the charging space is in a charging available state.
(10) The reservation managing device as recited in (9), when the charging space is in a charging available state, and the state acquiring unit has acquired information indicating absence of a vehicle in the charging space, the reservation managing unit outputs that the charging space is in a reservation available state
(11) The reservation managing device as recited in (9), wherein the reservation managing unit measures a time period during which the charging space is in a charging available state as a billing time period (or charging time period), and in a case where the state acquiring unit has acquired information indicating absence of a vehicle in the charging space, the reservation managing unit makes a payment based on the billing time period.
(12) The reservation managing device as recited in any one of from (1) to (11), wherein when the reservation managing unit receives temporarily leaving information indicating that the vehicle temporarily leaves, and the state acquiring unit has acquired information indicating absence of a vehicle in the charging space, the restricting unit puts the restricting device into a state for restricting use of the charging space.
(13) The reservation managing device as recited in any one of from (1) to (12), wherein when the reservation managing unit is in a temporarily leaving state in which it receives temporarily leaving information indicating that the charging space is not temporarily used, and the state acquiring unit has acquired information indicating presence of a vehicle, the restricting unit restricts supplying electric power from a charger to a vehicle.
(14) The reservation managing device as recited in any one of from (1) to (13), wherein when the reservation managing unit is in a temporarily leaving state in which it receives temporarily leaving information indicating that the charging space is not temporarily used, and the state acquiring unit has acquired information indicating absence of a vehicle, the restricting unit puts the restricting device into a state for restricting use of the charging space.
(15) The reservation managing device as recited in any one of from (1) to (14), wherein when the reservation managing unit is in a temporarily leaving state in which it receives temporarily leaving information indicating that the charging space is not temporarily used, and the reservation managing unit receive check-in information indicating that use of a charger provided in the charging space is enabled, the restricting unit puts the restricting device into a state for releasing restriction of use of the charging space.
(16) The reservation managing device as recited in any one of from (1) to (15), wherein when the charging space is in a temporarily leaving state, and the reservation managing unit receives check-in information indicating that use of a charger provided in the charging space is enabled, the restricting unit makes a state in which supplying electric power from a charger to a vehicle is enabled.
(17) The reservation managing device as recited in any one of from (1) to (16), wherein the charging space is provided with a charger capable of supplying electric power to a vehicle, and the reservation managing unit is configured to receive a reservation for using the charger.
(18) The reservation managing device as recited in any one of from (1) to (17), wherein the charging space is provided with a detecting device for detecting presence or absence of a vehicle.

The detecting device is a vehicle number reading device capable of reading a number of a vehicle.

The reservation information regarding the reservation includes a vehicle number of a user who made a reservation.

The reservation managing unit allows charging when a vehicle number read by the vehicle number reading device is identical with a vehicle number of the user who made the reservation.
(19) A charging space managing device, includes:
   a charging space state acquiring unit for acquiring information on presence or absence of a vehicle in a charging space, wherein the presence or absence of a vehicle is detected by a detecting device provided in the charging space;
   a charging space managing unit for transmitting the information on presence or absence of a vehicle acquired by the charging space state acquiring unit, to a reservation managing device for managing a reservation for the charging space, and for acquiring information on restriction of use of the charging space from the reservation managing device, and
   a charging space restricting unit for putting a restricting device provided in the charging space into a state for restricting use of the charging space, in a case where the charging space managing unit has acquired information on restriction of use of the charging space.
(20) The charging space managing device as recited in (19), wherein the charging space is provided with an informing device for outputting a use state of the charging space.

The charging space managing unit is configured, when having acquired information indicating that the charging space is in a reservation available state from the reservation managing device, to output, to the informing device, information indicating that the charging space is available for reservation.

The charging space managing unit is configured, when having acquired information indicating that the reservation has been accepted from the reservation managing device, to output information indicating that the charging space is reserved.
(21) The charging space managing device as recited in (19) or (20), when the charging space is in a reservation available state, and the charging space state acquiring unit has acquired information indicating that a vehicle is present in the charging space, the charging space managing unit outputs, to an informing device provided in the charging space, information indicating that the charging space is in an occupied state.
(22) The charging space managing device as recited in (21), wherein the charging space managing unit is configured to receive check-in information indicating that use of a charger provided in the charging space has been allowed, and in a case where the charging space is in an occupied state, and the charging space managing unit has received the check-in information, the charging space restricting unit enables charging by a charger to a vehicle.
(23) The charging space managing device as recited in any one of from (19) to (22), wherein the charging space managing unit is configured to receive check-in information indicating that use of a charger provided in the charging space has been allowed, and in a case where the charging space is in a reservation available state, and the charging space managing unit has received the check-in information, the charging space restricting unit puts the restricting device into a state for releasing restriction of use of the charging space.
(24) The charging space managing device as recited in (23), wherein the charging space managing unit is configured to receive check-in information indicating that use of a charger provided in the charging space is enabled.

When the charging space is in a reservation available state, and the charging space state acquiring unit acquires information indicating presence of a vehicle in the charging space after the charging space managing unit receives the check-in information, the charging space restricting unit enables supplying electric power from a charger to a vehicle.
(25) The charging space managing device as recited in any one of from (19) to (24), wherein the charging space managing unit is configured to receive check-in information indicating that use of a charger provided in the charging space is enabled.

When the charging space managing unit receives the check-in information and confirms that the charging space is in a reserved state, the charging space restricting units puts the restricting device into a state for releasing restriction of use of the charging space.
(26) The charging space managing device as recited in (25), when the charging space managing unit has confirmed that reservation identification information relating to the reservation and identification information relating to the check-in information are identical, the charging space restricting unit puts the restricting device into a state for releasing restriction of use of the charging space.
(27) The charging space managing device as recited in (25), wherein the charging space managing unit is configured to accept check-in information indicating that use of a charger provided in the charging space has been allowed.

When the charging space is in a reserved state, and the charging space managing unit has accepted the check-in information, the reservation managing unit outputs, to an informing device provided in the charging space, information indicating that the charging space is in a charging available state.
(28) The charging space managing device as recited in (27), when the charging space is in a charging available state, and the charging space acquiring unit has acquired information indicating absence of a vehicle in the charging space, the charging space managing unit outputs that the charging space is in a reservation available state
(29) The charging space managing device as recited in (27), wherein the charging space managing unit measures a time period during which the charging space is in a charging available state as a billing time period, and in a case where the charging space state acquiring unit has acquired information indicating absence of a vehicle in the charging space, the charging space managing unit makes a payment based on the billing time period.
(30) The charging space managing device as recited in any one of from (19) to (29), wherein the charging space is provided with a charger capable of supplying electric power to a vehicle.

The charging space managing unit is configured to accept a reservation for use of the charger.
(31) The charging space managing device as recited in any one of from (19) to (30), wherein the charging space is provided with a detecting device for detecting presence or absence of a vehicle.

The detecting device is a vehicle number reading device capable of reading a number of a vehicle.

The reservation information regarding the reservation includes a vehicle number of a user who made a reservation.

The charging space managing unit allows charging when a vehicle number read by the vehicle number reading device is identical with a vehicle number of the user who made the reservation.
(32) A method for managing a reservation, includes the steps of:
   acquiring information on presence or absence of a vehicle in a charging space;
   determining whether a use state of the charging space is a reservation available state based on the acquired information, and accepting a reservation for the charging space in a case where the charging space is in a reservation available state, and
   putting a restricting device provided in the charging space into a state for restricting use of the charging space, in a case where the reservation has been accepted.
(33) A program is provided for causing a server to execute the respective steps included in the method for managing a charging space as recited in (32)

### REFERENCE SIGNS LIST

100 . . . Reservation managing system,
101 . . . Charging space managing device (or device for managing one or a plurality of charging spaces),
102 . . . Managing server,
103 . . . User terminal,
110 . . . Charger,
111 . . . Power meter,
112 . . . External power supply,
120 . . . Detecting device,
130 . . . Restricting device,
132 . . . Main body,
134 . . . Restricting member,
140 . . . Informing device,
150 . . . Parking area,
211 . . . Charging space managing module,
212 . . . Charging space state acquiring module,
213 . . . Charging space restricting module,
311 . . . User terminal managing module,
312 . . . State acquiring module,
313 . . . Reservation managing module, and
314 . . . Restricting module.

1. A reservation managing device, comprising:
a state acquiring unit for acquiring information on presence or absence of a vehicle in a charging space;
a reservation managing unit for determining whether a use state of the charging space is a reservation available state based on the information acquired by the state acquiring unit, and for accepting a reservation for the charging space in a case where the charging space is in a reservation available state; and
a restricting unit for putting a restricting device provided in the charging space into a state for restricting use of the charging space, in a case where the reservation has been accepted by the reservation managing unit.

2. The reservation managing device according to claim 1, wherein the charging space is provided with an informing device for outputting a use state of the charging space, and
wherein the reservation managing unit is configured to output, to the informing device,
information indicating that the charging space is available for reservation, when having determined that the charging space is in a reservation available state, and
information indicating that the charging space is reserved, when having accepted the reservation.

3. The reservation managing device according to claim 2, wherein in a case where the charging space is in a reservation available state, and the state acquiring unit has acquired information indicating that a vehicle is present in the charging space, the reservation managing unit outputs, to the informing device, information indicating that the charging space is in an occupied state.

4. The reservation managing device according to claim 3, wherein the reservation managing unit is configured to accept check-in information indicating that use of a charger provided in the charging space has been allowed, and
in a case where the charging space is in an occupied state, and the reservation managing unit has accepted the check-in information, the restricting unit enables charging by a charger to a vehicle.

5. The reservation managing device according to claim 1, wherein the reservation managing unit is configured to accept check-in information indicating that use of a charger provided in the charging space has been allowed, and
in a case where the charging space is in a reservation available state, and the reservation managing unit has accepted the check-in information, the restricting unit puts the restricting device into a state for releasing restriction of use of the charging space.

6. The reservation managing device according to claim 5, wherein the reservation managing unit is configured to accept check-in information indicating that use of a charger provided in the charging space has been allowed, and
in a case where the charging space is in a reservation available state, and the reservation managing unit has accepted information indicating that a vehicle is present in the charging space, after accepting the check-in information, the restricting unit enables charging by a charger to a vehicle.

7. The reservation managing device according to claim 1, wherein the reservation managing unit is configured to accept check-in information indicating that use of a charger provided in the charging space has been allowed, and
in a case where the reservation managing unit has accepted the check-in information and confirmed that the charging space is in a reserved state, the restricting unit puts the restricting device into a state for releasing restriction of use of the charging space.

8. The reservation managing device according to claim 7, wherein in a case where the reservation managing unit has confirmed that reservation identification information relating to the reservation and identification information relating to the check-in information are identical, the restricting unit puts the restricting device into a state for releasing restriction of use of the charging space.

9. The reservation managing device according to claim 7, wherein the reservation managing unit is configured to accept check-in information indicating that use of a charger provided in the charging space has been allowed, and
in a case where the charging space is in a reserved state, and the reservation managing unit has accepted the check-in information, the reservation managing unit outputs, to the informing device provided in the charging space, information indicating that the charging space is in a charging available state.

10. A charging space managing device, comprising:
a charging space state acquiring unit for acquiring information on presence or absence of a vehicle in a charging space, the presence or absence of a vehicle being detected by a detecting device provided in the charging space;
a charging space managing unit for transmitting the information on presence or absence of a vehicle acquired by the charging space state acquiring unit, to a reservation managing device for managing a reservation for the charging space, and for acquiring information on restriction of use of the charging space from the reservation managing device, and
a charging space restricting unit for putting a restricting device provided in the charging space into a state for restricting use of the charging space, in a case where the charging space managing unit has acquired information on restriction of use of the charging space.

11. The charging space managing device according to claim 10, wherein the charging space is provided with an informing device for outputting a use state of the charging space, and
wherein the charging space managing unit is configured, when having acquired information indicating that the charging space is in a reservation available state, from the reservation managing device, to output, to the informing device, information indicating that the charging space is available for reservation, and
wherein the charging space managing unit is configured, when having acquired information indicating that the reservation has been accepted, from the reservation managing device, to output information indicating that the charging space is reserved.

12. The charging space managing device according to claim 10, wherein in a case where the charging space is in a reservation available state, and the charging space state acquiring unit has acquired information indicating that a vehicle is present in the charging space, the charging space managing unit outputs, to an informing device provided in the charging space, information indicating that the charging space is in an occupied state.

13. The charging space managing device according to claim 12, wherein the charging space managing unit is configured to receive check-in information indicating that use of a charger provided in the charging space has been allowed, and
in a case where the charging space is in an occupied state, and the charging space managing unit has received the check-in information, the charging space restricting unit enables charging by a charger to a vehicle.

14. The charging space managing device according to claim 10, wherein the charging space managing unit is configured to receive check-in information indicating that use of a charger provided in the charging space has been allowed, and
in a case where the charging space is in a reservation available state, and the charging space managing unit has received the check-in information, the charging space restricting unit puts the restricting device into a state for releasing restriction of use of the charging space.

15. A method for managing a reservation, comprising:
acquiring information on presence or absence of a vehicle in a charging space;
determining whether a use state of the charging space is a reservation available state based on the acquired information, and accepting a reservation for the charging space in a case where the charging space is in a reservation available state, and
putting a restricting device provided in the charging space into a state for restricting use of the charging space, in a case where the reservation has been accepted.
